(19) United States
(12) Patent Application Publication
(10) Pub. No.: US 2026/0129692 A1
(43) Pub. Date: May 7, 2026

(54) LINK ESTABLISHMENT PROCEDURES FOR ULTRA WIDEBAND SIDELINKS

(71) Applicant: QUALCOMM Incorporated, San Diego, CA (US)

(72) Inventors: Daniel PAZ, Atlit (IL); Michael LEVITSKY, Rehovot (IL); Gideon Shlomo KUTZ, Ramat Hasharon (IL); Tom BARAK, Rehovot (IL)

(21) Appl. No.: 18/940,683

(22) Filed: Nov. 7, 2024

(51) Int. Cl. H04W 76/10; H04B 1/7163; H04W 56/00; H04W 72/40; H04W 92/18

(52) U.S. Cl. CPC H04W 76/10; H04B 1/7163; H04W 56/0015; H04W 72/40; H04W 92/18

(57) ABSTRACT

Methods, systems, and devices for wireless communications are described. A user equipment (UE) may perform an initial pairing procedure with an extended reality (XR) device via a narrow band (NB) sidelink connection. The initial pairing procedure may establish an ultra wideband (UWB) sidelink connection between the UE and the XR device. The UE may transmit control signaling indicating a set of resources for the UWB sidelink connection. The set of resources may correspond to a local timeline for sidelink communications between the UE and the XR device. The UE may translate a cellular timeline for communications to generate the local timeline. The UE may transmit a triggering signal via the NB sidelink connection initiating sidelink communications between the UE and the XR device according to the local timeline for sidelink communications.

### FIELD OF TECHNOLOGY

The following relates to wireless communications, including link establishment procedures for ultra wideband sidelinks.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include performing an initial pairing procedure with an XR device via a narrow band (NB), where the initial pairing procedure establishes an ultra wideband (UWB) sidelink connection between the UE and the extended reality (XR) device, transmitting control signaling via the NB indicating one or more sidelink resources of the UWB sidelink connection for the XR device, where a local timeline for sidelink communications between the UE and the XR device associated with the one or more sidelink resources is translated from cellular timeline corresponding to the UWB sidelink connection, and transmitting a triggering signal, via the NB, initiating sidelink communications between the UE and the XR device via the one or more sidelink resources of the UWB sidelink connection, the sidelink communications satisfying the local timeline according to the translation from the cellular timeline.

A UE for wireless communications is described. The UE may include one or more memories storing processor executable code, and one or more processors coupled with the one or more memories. The one or more processors may individually or collectively be operable to execute the code to cause the UE to perform an initial pairing procedure with an XR device via a NB, where the initial pairing procedure establishes an UWB sidelink connection between the UE and the XR device, transmit control signaling via the NB indicating one or more sidelink resources of the UWB sidelink connection for the XR device, where a local timeline for sidelink communications between the UE and the XR device associated with the one or more sidelink resources is translated from cellular timeline corresponding to the UWB sidelink connection, and transmit a triggering signal, via the NB, initiating sidelink communications between the UE and the XR device via the one or more sidelink resources of the UWB sidelink connection, the sidelink communications satisfying the local timeline according to the translation from the cellular timeline.

Another UE for wireless communications is described. The UE may include means for performing an initial pairing procedure with an XR device via a NB, where the initial pairing procedure establishes an UWB sidelink connection between the UE and the XR device, means for transmitting control signaling via the NB indicating one or more sidelink resources of the UWB sidelink connection for the XR device, where a local timeline for sidelink communications between the UE and the XR device associated with the one or more sidelink resources is translated from cellular timeline corresponding to the UWB sidelink connection, and means for transmitting a triggering signal, via the NB, initiating sidelink communications between the UE and the XR device via the one or more sidelink resources of the UWB sidelink connection, the sidelink communications satisfying the local timeline according to the translation from the cellular timeline.

A non-transitory computer-readable medium storing code for wireless communications is described. The code may include instructions executable by one or more processors to perform an initial pairing procedure with an XR device via a NB, where the initial pairing procedure establishes an UWB sidelink connection between the UE and the XR device, transmit control signaling via the NB indicating one or more sidelink resources of the UWB sidelink connection for the XR device, where a local timeline for sidelink communications between the UE and the XR device associated with the one or more sidelink resources is translated from cellular timeline corresponding to the UWB sidelink connection, and transmit a triggering signal, via the NB, initiating sidelink communications between the UE and the XR device via the one or more sidelink resources of the UWB sidelink connection, the sidelink communications satisfying the local timeline according to the translation from the cellular timeline.

Some examples of the method, UEs, and non-transitory computer-readable medium described herein may further include operations, features, means, or instructions for receiving, from a network entity, an indication of a set of multiple resources corresponding to the cellular timeline, the set of multiple resources including the one or more sidelink resources and translating the set of multiple resources corresponding to the cellular timeline into the one or more sidelink resources that correspond to the local timeline for sidelink communications, where transmitting the control signaling indicating the one or more sidelink resources may be based on the translation.

In some examples of the method, UEs, and non-transitory computer-readable medium described herein, the set of multiple resources may be allocated for sidelink communications between the UE and the XR device according to a periodic communication pattern and the periodic communication pattern includes a time-domain resource grid according to the cellular timeline.

In some examples of the method, UEs, and non-transitory computer-readable medium described herein, a first set of time durations of the periodic communication pattern correspond to the UE and the XR device, and a second set of time durations of the periodic communication pattern correspond to a second UE and a second XR device.

Some examples of the method, UEs, and non-transitory computer-readable medium described herein may further include operations, features, means, or instructions for performing, during a first available duration of time allocated to the UE and the XR device according to the local timeline, a synchronization loop procedure via the UWB sidelink connection based on transmitting the triggering signal, where the synchronization loop procedure includes a time synchronization and a frequency synchronization between the UE and the XR device and communicating, during one or more second available durations of time allocated to the UE and the XR device according to the local timeline, one or more steady state sidelink communications between the UE and the XR device, where the one or more second available durations of time occur subsequent to the first available duration of time.

In some examples of the method, UEs, and non-transitory computer-readable medium described herein, the synchronization loop procedure may include operations, features, means, or instructions for receiving one or more first uplink reference signals, transmitting one or more downlink reference signals in accordance with a loop refinement procedure based on the one or more first uplink reference signals, receiving one or more second uplink reference signals based on transmitting the one or more downlink reference signals, and performing a downlink equalization response evaluation procedure based on receiving the one or more second uplink reference signals, one or more synchronization loop corrections via downlink control signaling, or a combination thereof.

In some examples of the method, UEs, and non-transitory computer-readable medium described herein, the time synchronization may include operations, features, means, or instructions for communicating a timeline synchronization message via the NB and recommunicating the timeline synchronization message via the NB one or more times based on satisfying a timeline accuracy threshold.

Some examples of the method, UEs, and non-transitory computer-readable medium described herein may further include operations, features, means, or instructions for repeating the synchronization loop procedure one or more times until one or more accuracy thresholds may be satisfied.

In some examples of the method, UEs, and non-transitory computer-readable medium described herein, the sidelink communications may be activated semi-persistently based on the triggering signal and in accordance with the local timeline.

Some examples of the method, UEs, and non-transitory computer-readable medium described herein may further include operations, features, means, or instructions for performing the initial pairing procedure may be based on a successful listen-before-talk (LBT) procedure.

Some examples of the method, UEs, and non-transitory computer-readable medium described herein may further include operations, features, means, or instructions for sending one or more first transmissions via the one or more sidelink resources of the UWB sidelink connection according to the local timeline, monitoring for one or more second transmissions via the one or more sidelink resources of the UWB sidelink connection according to the local timeline, and retransmitting the triggering signal based on the monitoring.

Some examples of the method, UEs, and non-transitory computer-readable medium described herein may further include operations, features, means, or instructions for generating a pre-equalization matrix the sidelink communications based on a channel reciprocity state.

In some examples of the method, UEs, and non-transitory computer-readable medium described herein, generating the pre-equalization matrix may include operations, features, means, or instructions for receiving one or more uplink channel estimation reference signals via an uplink channel, the uplink channel corresponding to the UWB sidelink connection, performing an estimation of one or more characteristics of a downlink channel based on receiving the one or more uplink channel estimation reference signals, and performing the sidelink communications according to one or more equalization matrices based on performing an evaluation of the one or more equalization matrices and based on a channel reciprocity according to the channel reciprocity state.

In some examples of the method, UEs, and non-transitory computer-readable medium described herein, generating the pre-equalization matrix may include operations, features, means, or instructions for transmitting one or more non-equalized downlink reference signals via a downlink channel, the downlink channel corresponding to the UWB sidelink connection, receiving, in a next available uplink slot according to the local timeline, an indication of one or more samples of the one or more non-equalized downlink reference signals, performing an estimation of one or more characteristics of the downlink channel based on receiving the indication, and performing the sidelink communications according to one or more equalization matrices based on performing an evaluation of the one or more equalization matrices and based on a lack of channel reciprocity according to the channel reciprocity state.

Some examples of the method, UEs, and non-transitory computer-readable medium described herein may further include operations, features, means, or instructions for receiving, from a network entity, one or more reference clock signals, where the one or more reference clock signals may be based on the cellular timeline, and where the XR device may be synchronized with the cellular timeline based on the one or more reference clock signals.

A method for wireless communications by an XR device is described. The method may include performing an initial pairing procedure with an XR device via a NB, where the initial pairing procedure establishes an UWB sidelink connection between a UE and the XR device, receiving control signaling via the NB indicating one or more sidelink resources of the UWB sidelink connection for the XR device, where a local timeline for sidelink communications between the UE and the XR device associated with the one or more sidelink resources is translated from cellular timeline corresponding to the UWB sidelink connection, and receiving a triggering signal, via the NB, initiating sidelink communications between the UE and the XR device via the one or more sidelink resources of the UWB sidelink connection, the sidelink communications satisfying the local timeline according to the translation from the cellular timeline.

An XR device for wireless communications is described. The XR device may include one or more memories storing processor executable code, and one or more processors coupled with the one or more memories. The one or more processors may individually or collectively be operable to execute the code to cause the XR device to perform an initial pairing procedure with an XR device via a NB, where the initial pairing procedure establishes an UWB sidelink connection between a UE and the XR device, receive control signaling via the NB indicating one or more sidelink resources of the UWB sidelink connection for the XR device, where a local timeline for sidelink communications between the UE and the XR device associated with the one or more sidelink resources is translated from cellular timeline corresponding to the UWB sidelink connection, and receive a triggering signal, via the NB, initiating sidelink communications between the UE and the XR device via the one or more sidelink resources of the UWB sidelink connection, the sidelink communications satisfying the local timeline according to the translation from the cellular timeline.

Another XR device for wireless communications is described. The XR device may include means for performing an initial pairing procedure with an XR device via a NB, where the initial pairing procedure establishes an UWB sidelink connection between a UE and the XR device, means for receiving control signaling via the NB indicating one or more sidelink resources of the UWB sidelink connection for the XR device, where a local timeline for sidelink communications between the UE and the XR device associated with the one or more sidelink resources is translated from cellular timeline corresponding to the UWB sidelink connection, and means for receiving a triggering signal, via the NB, initiating sidelink communications between the UE and the XR device via the one or more sidelink resources of the UWB sidelink connection, the sidelink communications satisfying the local timeline according to the translation from the cellular timeline.

A non-transitory computer-readable medium storing code for wireless communications is described. The code may include instructions executable by one or more processors to perform an initial pairing procedure with an XR device via a NB, where the initial pairing procedure establishes an UWB sidelink connection between a UE and the XR device, receive control signaling via the NB indicating one or more sidelink resources of the UWB sidelink connection for the XR device, where a local timeline for sidelink communications between the UE and the XR device associated with the one or more sidelink resources is translated from cellular timeline corresponding to the UWB sidelink connection, and receive a triggering signal, via the NB, initiating sidelink communications between the UE and the XR device via the one or more sidelink resources of the UWB sidelink connection, the sidelink communications satisfying the local timeline according to the translation from the cellular timeline.

Some examples of the method, XR devices, and non-transitory computer-readable medium described herein may further include operations, features, means, or instructions for performing, during a first available duration of time allocated to the UE and the XR device according to the local timeline, a synchronization loop procedure via the UWB sidelink connection based on receiving the triggering signal, where the synchronization loop procedure includes a time synchronization and a frequency synchronization between the UE and the XR device and communicating, during one or more second available durations of time allocated to the UE and the XR device according to the local timeline, one or more steady state sidelink communications between the UE and the XR device, where the one or more second available durations of time occur subsequent to the first available duration of time.

In some examples of the method, XR devices, and non-transitory computer-readable medium described herein, the synchronization loop procedure may include operations, features, means, or instructions for transmitting one or more first uplink reference signals, receiving one or more downlink reference signals in accordance with a loop refinement procedure based on the one or more first uplink reference signals, and transmitting one or more second uplink reference signals based on transmitting the one or more downlink reference signals.

In some examples of the method, XR devices, and non-transitory computer-readable medium described herein, the time synchronization may include operations, features, means, or instructions for communicating a timeline synchronization message via the NB and recommunicating the timeline synchronization message via the NB one or more times based on satisfying a timeline accuracy threshold.

Some examples of the method, XR devices, and non-transitory computer-readable medium described herein may further include operations, features, means, or instructions for repeating the synchronization loop procedure one or more times until one or more accuracy thresholds may be satisfied.

In some examples of the method, XR devices, and non-transitory computer-readable medium described herein, the sidelink communications may be activated semi-persistently based on the triggering signal and in accordance with the local timeline.

Some examples of the method, XR devices, and non-transitory computer-readable medium described herein may further include operations, features, means, or instructions for performing the initial pairing procedure may be based on a successful LBT procedure.

Some examples of the method, XR devices, and non-transitory computer-readable medium described herein may further include operations, features, means, or instructions for generating a pre-equalization matrix for the sidelink communications based on a channel reciprocity state.

In some examples of the method, XR devices, and non-transitory computer-readable medium described herein, generating the pre-equalization matrix may include operations, features, means, or instructions for transmitting one or more uplink channel estimation reference signals via an uplink channel, the uplink channel corresponding to the UWB sidelink connection and performing the sidelink communications according to the pre-equalization matrix based on transmitting the one or more uplink channel estimation reference signals and based on a channel reciprocity according to the channel reciprocity state.

In some examples of the method, XR devices, and non-transitory computer-readable medium described herein, generating the pre-equalization matrix may include operations, features, means, or instructions for receiving one or more non-equalized downlink reference signals via a downlink channel based on an absence of a channel reciprocity according to the channel reciprocity state, the downlink channel corresponding to the UWB sidelink connection, sampling the one or more non-equalized downlink reference signals, transmitting, in a next available uplink slot according to the local timeline, an indication of one or more samples of the one or more non-equalized downlink reference signals, and performing the sidelink communications according to the pre-equalization matrix based on sampling the one or more non-equalized downlink reference signals and based on a lack of channel reciprocity according to the channel reciprocity state.

Some examples of the method, XR devices, and non-transitory computer-readable medium described herein may further include operations, features, means, or instructions for receiving one or more reference clock signals, where the one or more reference clock signals may be based on the cellular timeline, and where the XR device may be synchronized with the cellular timeline based on the one or more reference clock signals.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports link establishment procedures for ultra wideband (UWB) sidelinks in accordance with one or more aspects of the present disclosure.

FIG. 2 shows an example of a wireless communications system that supports link establishment procedures for UWB sidelinks in accordance with one or more aspects of the present disclosure.

FIG. 3 shows an example of a communication timeline that supports link establishment procedures for UWB sidelinks in accordance with one or more aspects of the present disclosure.

FIG. 4 shows an example of a system architecture that supports link establishment procedures for UWB sidelinks in accordance with one or more aspects of the present disclosure.

FIG. 5 shows an example of a process flow that supports link establishment procedures for UWB sidelinks in accordance with one or more aspects of the present disclosure.

FIGS. 6 and 7 show block diagrams of devices that support link establishment procedures for UWB sidelinks in accordance with one or more aspects of the present disclosure.

FIG. 8 shows a block diagram of a communications manager that supports link establishment procedures for UWB sidelinks in accordance with one or more aspects of the present disclosure.

FIG. 9 shows a diagram of a system including a device that supports link establishment procedures for UWB sidelinks in accordance with one or more aspects of the present disclosure.

FIGS. 10 and 11 show block diagrams of devices that support link establishment procedures for UWB sidelinks in accordance with one or more aspects of the present disclosure.

FIG. 12 shows a block diagram of a communications manager that supports link establishment procedures for UWB sidelinks in accordance with one or more aspects of the present disclosure.

FIG. 13 shows a diagram of a system including a device that supports link establishment procedures for UWB sidelinks in accordance with one or more aspects of the present disclosure.

FIGS. 14 through 18 show flowcharts illustrating methods that support link establishment procedures for UWB sidelinks in accordance with one or more aspects of the present disclosure.

### DETAILED DESCRIPTION

In some wireless communication systems, an extended reality (XR) device may support applications involving significant computation complexity (e.g., video compression, sensor data processing, and other applications). However, the processing capabilities of the XR device may be limited based on one or more power conditions (e.g., a battery size of the XR device, a heat dissipation ability of the XR device, a size of the XR device, or other conditions). To satisfy the power conditions, the XR device may shift (e.g., split or share) computing tasks with a companion device (e.g., user equipment (UE)). In some cases, the XR device may shift a significant amount of computing processes to the UE to satisfy the power conditions. In some examples, the XR device and the UE may establish an ultra wideband (UWB) sidelink connection between the devices.

The UWB sidelink connection may utilize an unlicensed frequency band, and may have a relatively large bandwidth (e.g., 500 MHz or greater). In such examples, communicating via the UWB sidelink connection may enable the XR device to shift computing processes to the UE based on the UWB sidelink connection satisfying a data throughput (e.g., being capable of communicating with a high bitrate). However, in such examples, using the UWB sidelink connection continuously (e.g., at all times regardless of communication traffic) may lead to increased overhead, and may be inefficient. Acquisition or connection procedures between the UE and the XR device may fail if a complexity or signaling overhead for such a procedure exceeds a capability of the XR device. Further, UEs may be synchronized with one or more network devices according to a cellular timeline (e.g., where communications with the network entity are aligned with the cellular timing). If communications between the UE and the XR device are not timing aligned, or if a timeline for the UE and the XR communications conflict with the cellular timing, then communications may fail and user experience may be decreased. For example, if communications between the UE and the XR device expend large amounts of power or rely on high complexity processing, the XR device may not fail to receive or transmit such communications. If UE and XR communications are low throughput, then such communications may not satisfy standards for XR communications or applications.

The present disclosure provides techniques for the XR device and the UE to establish an UWB sidelink connection (e.g., for process sharing or shifting) via a narrowband (NB) sidelink connection. In some examples, the XR device and the UE may perform an initial pairing procedure via the NB sidelink connection. The initial pairing procedure may accomplish an initial acquisition of timing and frequency resources for the UWB sidelink connection, and may establish the UWB sidelink connection. In some examples, the XR device and the UE may initiate a shared time counting system such that a shared local timeline is established and maintained for both the XR device and the UE. Additionally, or alternatively, the local timeline may be translated from a cellular timeline by the UE. Techniques described herein may further support triggering of direct transmissions over the UWB sidelink connection, where such communications are aligned with the cellular (e.g., or WWAN) timeline grid. Techniques described herein may also support synchronization loop refinement and tracking directly over the UWB to support transmission equalization-based waveforms. Techniques described herein may also support acquiring of transmission pre-equalization matrices on the UE side, which may be employed for UE transmissions toward the XR device or other power-limited devices.

In some examples, the UE may indicate one or more sidelink resources to the XR device for sidelink communications via the UWB sidelink connection. In such examples, the sidelink resources may correspond to an allotted duration of time for sidelink communications according to the cellular timeline (e.g., configured by a network according to the cellular timeline). In some examples, the UE may translate the indication of the sidelink resources to correspond to the local timeline for sidelink communications. In some examples, the UE may transmit a triggering signal to the XR device via the NB sidelink connection to initiate sidelink communications via the UWB sidelink connection. In such examples, the XR device and the UE may perform sidelink communications via the UWB sidelink connection such that the sidelink communications satisfy (e.g., are communicated within) the allotted duration of time.

Aspects of this disclosure are illustrated by and described in the context of wireless communications systems. Aspects of the disclosure are further described in the context of communication timelines, system architectures, and process flows. Aspects of the disclosure are further illustrated by and described with reference to apparatus diagrams, system diagrams, and flowcharts that relate to link establishment procedures for UWB sidelink connections.

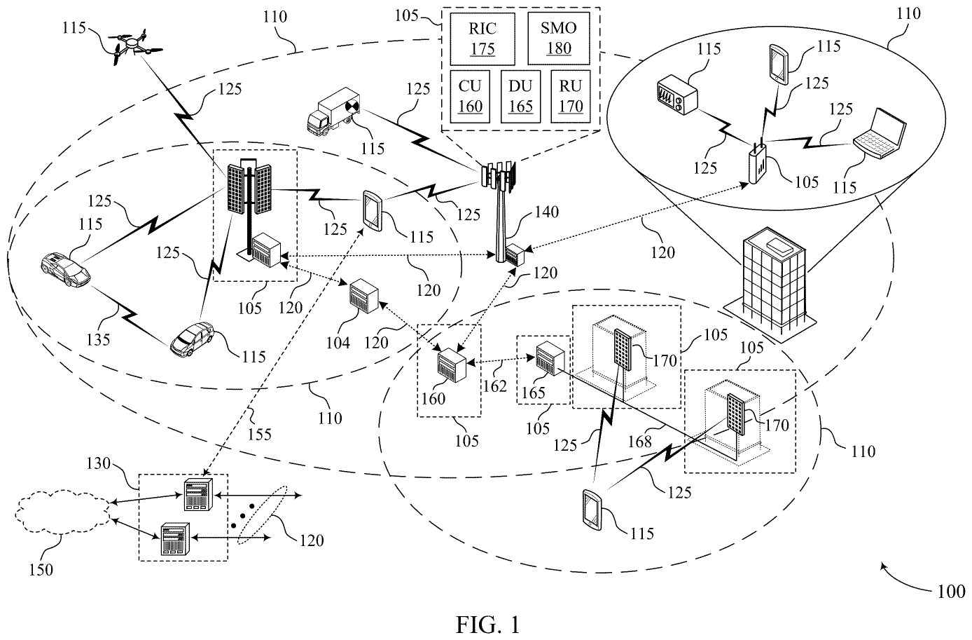

FIG. 1 shows an example of a wireless communications system 100 that supports link establishment procedures for UWB sidelinks in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support link establishment procedures for UWB sidelinks as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δƒ) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δƒₘₐₓ·N_{ƒ}) seconds, for which Δƒₘₐₓ may represent a supported subcarrier spacing, and N_{ƒ} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{ƒ}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example, a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may support techniques for establishing a UWB sidelink connection between a UE 115 and a XR device 205-a via a NB sidelink connection. The UE 115 and the XR device 205-a may perform an initial pairing procedure via the NB sidelink connection. The initial pairing procedure may establish the UWB sidelink connection between the UE 115 and the XR device 205-a. The UE 115 may transmit, via the NB sidelink connection, an indication of a set of resources for UWB sidelink communications. The set of resources may correspond to a local timeline for sidelink communications, which may be translated by the UE 115 from a cellular timeline. In some examples, the UE 115 and the XR device 205-a may perform one or more synchronization loop refinement procedures to synchronize timing resources and frequency resources between the UE 115 and the XR device 205-a. Additionally, or alternatively, the UE 115 and the XR device 205-a may determine a pre-equalization matrix for one or more downlink communications, where the downlink communications are performed via the UWB sidelink connection.

In some examples, based on performing the initial pairing procedure, the sidelink resource indication, the synchronization loop refinement procedures, and determining the pre-equalization matrix, the UE 115 and the XR device 205-a may perform ongoing sidelink communications (e.g., steady state communications) via the UWB sidelink connection. The techniques described herein may enable the XR device 205-a to shift processing tasks to the UE 115.

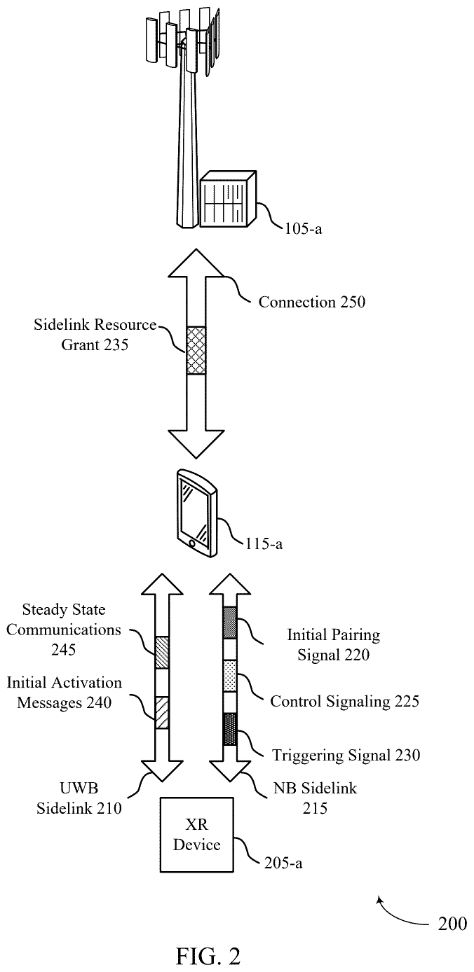

FIG. 2 shows an example of a wireless communications system 200 that supports link establishment procedures for UWB sidelinks in accordance with one or more aspects of the present disclosure. The wireless communications system 200 may include a network entity 105-a, a XR device 205-a, and a companion UE 115-a, which may be examples of a network entity 105, a XR device 205, and UE 115 respectively as described with reference to FIG. 1. In some cases, the companion UE 115-a may implement link establishment procedures for UWB sidelinks.

In some cases, the XR device 205-a may support applications that involve significant processing overhead (e.g., sensor data processing, video compression, and other processes). The XR device 205-a may be a device that is relatively small and light (e.g., similar in size and weight to eyeglasses) to support on-the-go use cases. In such cases, the XR device 205-a battery may correspondingly be relatively small and light (e.g., compared to a UE battery or other consumer device battery). Further, in such cases, the XR device 205-a may have limited heat dissipation capabilities based on the XR device 205-a having a relatively small surface area corresponding to the overall device size. In such cases, the power consumption of the XR device 205-a may be relatively limited to support improved battery life.

In some cases, to maintain processing overhead while improving battery life, the XR device 205-a may offload (e.g., shift or split) processing tasks to the companion UE 115-a. In some cases, the XR device 205-a may offload a significant portion of tasks to the companion UE 115-a. In such cases, the XR device 205-a may share sensor data directly with the companion UE 115-a, and may receive rendered video data from the companion UE 115-a (e.g., instead of performing the video rendering at the XR device 205-a). In such cases, the XR device 205-a and the companion UE 115-a may utilize an UWB sidelink connection 210 to perform the offloading and shared processing. The UWB sidelink connection 210 may support relatively low latency and high throughputs (e.g., high bitrates, high data rates, and other performance metrics), which may be beneficial for offloading processes between the XR device 205-a and the companion UE 115-a. In some cases, the UWB sidelink connection 210 may have a relatively high bandwidth (e.g., at least 500 MHz). However, in such examples, using the UWB sidelink connection 210 continuously (e.g., established at all times regardless of communication traffic) may lead to increased overhead, and may be inefficient. Aspects of the disclosure are initially described in the context of wireless communications systems that support link establishment procedures for UWB sidelinks.

In accordance with examples disclosed herein, the companion UE 115-a and the XR device 205-a may establish the UWB sidelink connection 210 with one or more link establishment procedures via a narrowband (NB) sidelink connection 215. In some implementations, the companion UE 115-a and the XR device 205-a may implement the NB sidelink connection 215 via a narrowband sidelink of a relatively smaller bandwidth than the UWB sidelink connection 210. In some other implementations, the companion UE 115-a and the XR device 205-a may implement the NB sidelink connection 215 via one or more other connection types (e.g., a cellular connection, a Wi-Fi connection, a Bluetooth or Bluetooth Low Energy (BLE) connection, or other wireless technologies). In some examples, the UWB sidelink connection 210 and the NB sidelink connection 215 may be synchronized in time (e.g., having tightly synchronized timing and utilizing the same reference clock signal). Additionally, or alternatively, the NB sidelink connection 215 may be maintained between the XR device 205-a and the companion UE 115-a continuously (e.g., at all times).

In some implementations, the XR device 205-a and the companion UE 115-a may perform an initial pairing signal 220 (e.g., an initial pairing signal of an initial pairing procedure) via the NB sidelink connection 215. In some examples, the initial pairing signal 220 may include a listen-before-talk (LBT) mechanism (e.g., to support co-existence with other devices on the NB sidelink connection 215). In some examples, LBT procedures may be asynchronous, where the exact timing of the transmission cannot be predetermined or known in advance. In such examples, initial transmission triggering or activation may be provided to the receiver side by a message over the narrowband channel, however, such a message may not be linked directly to the transmitted message timing because it may not be guaranteed to directly align with the cellular timeline. According to techniques described herein, performing the initial pairing signal 220 may be based on satisfying the LBT procedure (e.g., a successful LBT procedure). In some examples, the initial pairing signal 220 may include device initial discovery and device initial pairing between the XR device 205-a and the companion UE 115-a via the NB sidelink connection 215. Additionally, or alternatively, the initial pairing signal 220 may include an initial acquisition of timing (e.g., time-domain resources) and frequency (e.g., frequency-domain resources) for UWB communications. Additionally, or alternatively, a local timeline may be established between the companion UE 115-a and the XR device 205-a based on one or more communications via the NB sidelink connection 215. In some examples, the initial pairing signal 220 may perform initial UWB configurations such that the UWB sidelink connection 210 may be established between the XR device 205-a and the companion UE 115-a.

In some implementations, communications between the XR device 205-a and the companion UE 115-a may be synchronized according to a network or cellular timeline (e.g., scheduled by a network). In some examples, the XR device 205-a and the companion UE 115-a may be collocated with (e.g., nearby, or within a threshold distance of, such as within a 10-meter radius of) one or more other pairs of UEs and XR devices. In such examples, communications between the collocated pairs of UEs and XR devices may cause interference between the XR device 205-a and the companion UE 115-a, or between other UE and XR device pairs. Further, multiple pairs of UEs and XR devices may communicate via the same UWB sidelink connection 210 through time division multiplexing. As such, in some implementations, each pair of UE and XR devices may be configured by a wireless wide area network (WWAN) with a set of non-overlapping resources (e.g., time-domain and frequency-domain resources). In such examples, each UE and XR device pair, including the XR device 205-a and the companion UE 115-a, may communicate during a periodic, allotted duration of time according to the cellular timeline. In such examples, the network may allocate (e.g., schedule) the non-overlapping resources for the XR device 205-a and the companion UE 115-a within the allotted duration of time. Additionally, or alternatively, the network may indicate one or more cellular-based reference clocks such that communications over either the NB sidelink connection 215, the UWB sidelink connection 210, or both may be synchronized to the network-based reference clocks.

In some implementations, the companion UE 115-a may receive, from the network, an indication of a sidelink resource grant 235 via a connection 250 (e.g., a cellular connection, or a WWAN connection) including one or more resources for sidelink communications according to the cellular timeline. In some examples, the companion UE 115-a may translate the sidelink resource grant 235 from the cellular timeline to the local timeline (e.g., identify instances in time according to the local timeline for the one or more resources based on the cellular timeline). In some implementations, the companion UE 115-a may transmit control signaling 225 to the XR device 205-a (e.g., performing an initial configuration of the UWB sidelink connection 210) via the NB sidelink connection 215.

In some examples, the companion UE 115-a may transmit an indication of a set of resources (e.g., time-domain and frequency-domain resources) for uplink and downlink communications between the XR device 205-a and the companion UE 115-a via the UWB sidelink connection 210. In some examples, the frequency resources for uplink communications may be the same as the frequency resources for downlink communications (e.g., the same or different UWB FD resources or channels may be used for different link directions). Additionally, or alternatively, the frequency resources for uplink communications and downlink communications may be different. In such examples, the XR device 205-a and the companion UE 115-a may communicate according to a sub-band full-duplex mode (e.g., via one or more sub-bands of the UWB sidelink connection 210). In such examples where the frequency resources for uplink communications and downlink communications overlap in time, the companion UE 115-a may indicate a pattern for time division duplexing (TDD) the uplink communications and downlink communications. In some examples, the companion UE 115-a may indicate a set of uplink resources for communicating a set of synchronization reference signals (RS) via the UWB sidelink connection 210. Such resources may be configured for synchronization loop refinement (e.g., residual parts per million (PPM) error (ppm_err), frequency offset (FO), sampling rate error, time clock counter error, among other examples) directly over UWB as described herein (e.g., which may support transmission equalization based transmissions in downlink directions to support a very low complexity XR receiver).

If a channel reciprocity assumption is held, then uplink resources for channel estimation reference signals for downlink equalization response estimation on the UE side (e.g., the transmitter side) support may support transmission equalization-based waveforms in downlink signaling. If a channel reciprocity assumption is not held, then the downlink resources for channel estimation reference signals or resources for transmission of non-equalized downlink reference signals may support downlink CSI acquisition for transmission equalization evaluation. Such downlink reference signals may be sampled and compressed on the receiver side (e.g., at the XR device 205-a) and the compressed samples may be indicated to the companion UE 115-a via uplink signaling to be used for downlink channel estimation procedures that will take place at the companion UE 115-a. Uplink resources may be configured for transmitting an indication of downlink reference signal compressed samples or reporting in uplink signaling to allow transmission equalizer response evaluation for downlink signaling at the companion UE 115-a. Configuration of such uplink indications or reporting resources may be configured relative to the downlink reference signal transmission time.

In some implementations, the companion UE 115-a may transmit a triggering signal 230 to the XR device 205-a via the NB sidelink connection 215 to initiate sidelink communications via the UWB sidelink connection 210. In some examples, the triggering signal 230 may activate sidelink communications via the UWB sidelink connection 210 semi-persistently according to the network timeline and the allotted duration of time. For example, the triggering signal 230 may activate sidelink communications during multiple allotted durations of time (e.g., periodic sequences of sidelink communications). For example, the triggering may be addressed as a semi-persistent activation of UWB sidelink connection 210 that may initiate a periodic pattern of special sequences of uplink and downlink reference signal transmissions and related signaling and responses, which may allow a continuous data stream relying on transmission of equalized waveforms in the downlink direction (e.g., over assigned UWB time domain-frequency domain resource grids for the UE-XR pair). When the UE 115-a is triggered, the sequence may start at the correct point of time in the periodic pattern. Such a sequence starting point may be assumed (e.g., determined or identified) at both the UE 115-a and the XR Device 205-a, and activation may be relative to the triggering message (e.g., the triggering signal 230) over the NB sidelink connection 215 (e.g., regardless of an exact timing of the transmission of the triggering signal 230).

In some implementations, the companion UE 115-a and the XR device 205-a may perform an initial activation phase based on communicating the triggering signal 230. In some examples, given a shared timeline (e.g., a shared counting established based on the narrowband channel), a narrowband message may provide an initial transmission triggering or activation for the UWP sidelink connection 210. Following the triggering, both the UE and 115-a and the XR device 205-a may align to a nearest valid uplink or downlink period to start (e.g., based on a cellular timeline) after the message is received. The initial activation phase may include a sequence of one or more initial activation messages 240. The companion UE 115-a and the XR device 205-a may perform the initial activation phase aligned to the next available (e.g., closest in time) allotted duration of time according to the cellular timeline. For example, companion UE 115-a may transmit the triggering signal 230 before (e.g., outside) a first allotted duration of time. As such, the companion UE 115-a and the XR device 205-a may refrain from performing the initial activation phase until the first allotted duration of time. Additionally, or alternatively, the companion UE 115-a may monitor during the initial activation phase. In some examples, the initial procedure may not be acknowledged (e.g., ACKed), or the UE 115-a does not receive an ACK message from the XR device 205-a), then the companion UE 115-a may perform the triggering again. For example, the companion UE 115-a may detect that the XR device 205-a is performing a different sequence of steps than the steps of the initial activation phase (e.g., not adhering to the predefined steps of the initial activation phase or not communicating any signaling) based on monitoring. In such examples, the companion UE 115-a may retransmit the triggering signal 230 via the NB sidelink connection 215 one or more times until the companion UE 115-a detects adherence to the initial activation phase.

In some implementations, the initial activation phase may include an initial synchronization loop refinement procedure. NB initial sync accuracy (e.g., parts per million (PPM) error (ppm_err), frequency offset (FO), time offset (TO), among other metrics) may enable initial acquisition procedures for the UWB sidelink connection 210. However, NB transmissions may be asynchronous and based on successful LBT procedures (e.g., LBT-limited) and may correspondingly be incapable of providing frequent and periodic synchronization loop updates for some scenarios (e.g., equalization-based communications). In such implementations, the XR device 205-a may, during a first available uplink slot within an allotted duration of time, transmit one or more uplink RSs (UL RSs). The companion UE 115-a may receive and measure the one or more UL RS. The companion UE 115-a may determine (e.g., derive, calculate, or estimate) a PPM error corresponding to a FO, a TO, or both between the companion UE 115-a and the XR device 205-a based on receiving the RS. Additionally, or alternatively, the companion UE 115-a may determine (e.g., derive, calculate, or estimate) one or more corrections for the XR device 205-a based on the PPM error. For example, the corrections may include one or more adjustments to a clock source if the XR device 205-a (e.g., a local oscillator, a phase lock loop (PLL), a clock synthesizer, or other clock sources). Accordingly, the companion UE 115-a may transmit the one or more corrections to the XR device 205-a via the UWB sidelink connection 210, the NB sidelink connection 215, or both.

Additionally, or alternatively, the companion UE 115-a and the XR device 205-a may periodically (e.g., repeatedly) perform one or more synchronization loop refinement procedures (e.g., on-going synchronization loop refinement procedures) to maintain an accurate synchronization of the UWB sidelink connection 210 (e.g., by mitigating channel TO and FO mismatches and errors). In some implementations, the companion UE 115-a and the XR device 205-a may perform the one or more synchronization loop refinements based on an availability of RS within a scheduled communication pattern. Additionally, or alternatively, the companion UE 115-a and the XR device 205-a may perform the one or more synchronization loop refinements until a timing accuracy converges to a threshold accuracy.

In some implementations, the companion UE 115-a and the XR device 205-a may perform steady state communications 245 (e.g., data communications) based on performing the initial activation phase and the timing accuracy satisfying the threshold. In such implementations, the companion UE 115-a and the XR device 205-a may communicate one or more uplink messages, one or more downlink messages, or any combination thereof (e.g., according to the resource allocations from the network and the translation by the companion UE 115-a).

In some implementations, the companion UE 115-a and the XR device 205-a may determine a pre-equalization matrix for one or more downlink communications. The companion UE 115-a and the XR device 205-a may perform one or more different procedures to acquire the pre-equalization matrix based on a channel reciprocity assumption (e.g., whether there is channel reciprocity or not between an uplink and a downlink channel).

In some implementations, the companion UE 115-a and the XR device 205-a may maintain channel reciprocity. In such implementations, the XR device 205-a may transmit one or more channel estimation RSs via an uplink channel (e.g., the uplink channel being a subset of the UWB sidelink connection 210). The companion UE 115-a may receive the channel estimation RS and estimate one or more characteristics of a downlink channel based on the channel reciprocity (e.g., the downlink channel being a subset of the UWB sidelink connection 210, and the downlink channel having the same or similar channel characteristics as the uplink channel). Accordingly, the companion UE 115-a may determine an equalization matrix to apply to downlink communications between the companion UE 115-a and the XR device 205-a via the UWB sidelink connection 210. The companion UE 115-a may communicate one or more downlink messages based on estimating the downlink channel and determining the equalization matrix.

Additionally, or alternatively, the companion UE 115-a and the XR device 205-a may communicate with channel reciprocity being absent (e.g., the uplink channel and the downlink channel having different properties, correspond to different channel parameters or channel quality, or may correspond to different sets of resources). In such implementations, the companion UE 115-a may transmit one or more non-equalized downlink RS (DL RS) via the downlink channel. The XR device 205-a may receive and sample (e.g., quantize and compress) the DL RS. Further, the XR device 205-a may transmit an indication of the samples on the next available uplink slot. The companion UE 115-a may receive the indication of the samples and may determine (e.g., derive, calculate, or estimate) one or more characteristics of the downlink channel based on receiving the samples on the uplink channel. Additionally, or alternatively, the companion UE 115-a may perform the pre-equalization matrix procedure to evaluate (e.g., compare, determine, or select) the pre-equalization matrix based on determining the one or more characteristics of the downlink channel (e.g., regardless of a channel reciprocity being present or absent).

Additionally, or alternatively, the companion UE 115-a and the XR device 205-a may determine the pre-equalization matrix periodically according to one or more parameters (e.g., a transmission equalization (EQ) (Tx EQ) refresh period parameter). Accordingly, the companion UE 115-a and the XR device 205-a may semi-continuously (e.g., at a regular interval of slots) refresh the pre-equalization matrix by repeating the evaluation process. Additionally, or alternatively, the companion UE 115-a and the XR device 205-a may perform additional timing corrections (e.g., other timing corrections than the corrections of the synchronization loop refinements) between the devices by evaluating the pre-equalization matrix. For example, after the initial triggering, the UWB sidelink transmissions may continue in a semi-continuous way according to the UWB uplink and downlink resource assignment (e.g., providing for some periodic activity pattern and some configured time division duplexing pattern, if relevant), while continuous synchronization tracking is preserved between the XR device 205-a and the UE 115-a over the UWB sidelink connection 210, such that both the UE 115-a and the XR device 205-a may maintain continuous alignment between the cellular timeline and the assigned for the UWB time domain resource grid (e.g., avoiding any mutual interference with some other collocated UE-XR pairs). Accordingly, by implementing the techniques discussed herein for evaluating the pre-equalization matrix, the XR device 205-a may refrain from performing equalization computations (e.g., the computations may be performed at the companion UE 115-a instead), thus relatively reducing the processing complexity and power consumption for the XR device 205-a.

According to the techniques described herein, the companion UE 115-a and the XR device 205-a may establish the UWB sidelink connection 210 via the NB sidelink connection 215, and may accordingly reduce power consumption associated with the UWB sidelink connection 210 by refraining from continuously maintaining the connection at all times. The companion UE 115-a and the XR device 205-a may further communicate while satisfying throughout (e.g., high bit rate) and low latency requirements, without relying on power expenditures that exceed the capabilities of the XR device 205-a. Techniques described herein may be applied between a host device (e.g., the companion UE 115-a, or another wireless device) and a low-power device (e.g., such as the XR device 205-a or another wireless device). The techniques described herein may support complete UWB-based XR-sidelink link establishment processes between the companion UE 115-a and the XR device 205-a, such that pre-equalized transmissions from the companion UE 115-a to the XR device 205-a are supported. Techniques described herein cover discovery and initial pairing, time alignment between NB-assisted UWB and WWAN timelines (e.g., such that the UWB-based sidelink can follow WWAN local downlink reception timelines), and dedicated signaling and configuration supporting waveforms for low complexity, low latency, high bit rate, UWB-based sidelink communications.

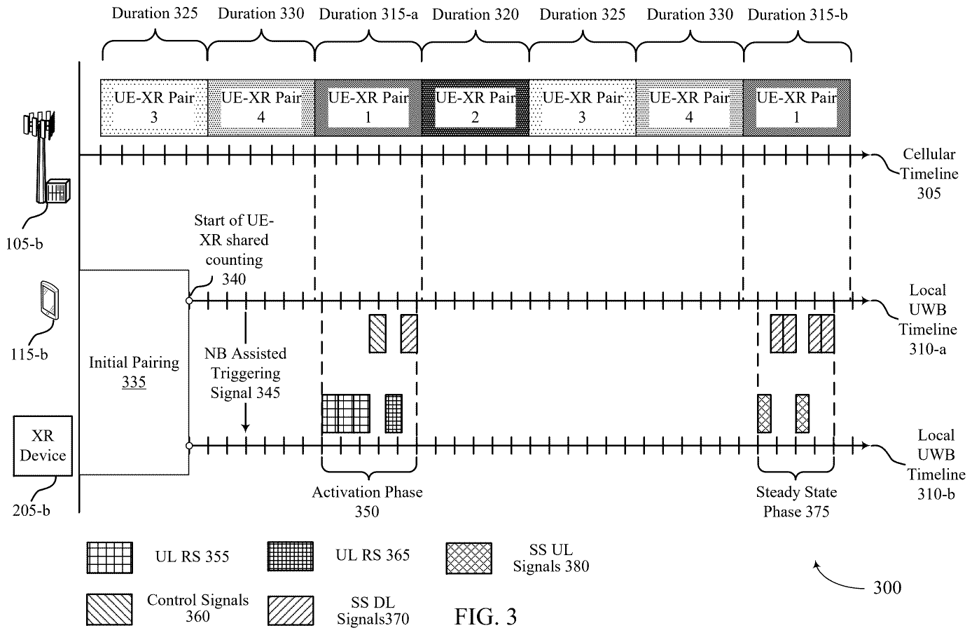

FIG. 3 shows an example of a communication timeline 300 that supports link establishment procedures for UWB sidelinks in accordance with one or more aspects of the present disclosure. The communication timeline 300 may implement or may be implemented by aspects of the wireless communications system 100 or the wireless communications system 200. For example, the communication timeline 300 may include a companion UE 115-b, a network entity 105-b, and an XR device 205-b, which may be examples of a UE 115, network entity 105, and an XR device 205 respectively, as described with reference to FIGS. 1 and 2.

In some implementations, the communication timeline 300 may include a cellular timeline 305 (e.g., WWAN timeline), a local UWB timeline 310-a, and a local UWB timeline 310-b. In some examples, the local UWB timeline 310-a and the local UWB timeline 310-b may maintain a shared timeline (e.g., the local UWB timeline 310-a and the local UWB timeline 310-b may be the same timeline) and may be based on one or more cellular reference clock signals. Additionally, or alternatively, the cellular timeline 305, the local UWB timeline 310-a, and the local UWB timeline 310-b may form a time-domain resource grid for sidelink communications.

To support techniques described herein, each UE-XR pair may utilize a time counting that is shared between the devices, which can be used to map assigned resources for UWB time domain resources. Time domain resource assignments for the UWB sidelink may be provided in terms of time unites corresponding to a cellular timeline 305 (e.g., which may be indicated by the network entity 105-b to the companion UE 115-b). The time domain resources for the UWB sidelink may translated to a local timeline shared by the companion UE 115-b and the XR device 205-b, where time counting is established first based on the NB channel. The shared timeline and synchronization (e.g., the local UWB timeline) should have a sufficient time resolution and granularity to be able mark or otherwise determine a beginning of an allocation for UWB periodic time domain resource pattern or resource grinds. Such time granularity synchronization may rely on multiple transmission over the NB channel until the level of convergence for XR timeline synchronization is satisfied. UWB time domain resources assigned for the specific UE-XR pair may be configured by the companion UE 115-b to the XR device 205-b on top of this established shared timeline (e.g., the configuration may be accomplished via the NB channel). After UWB related configurations are indicated to the XR device 205-b, UWB sidelink initial transmissions and PHY procedures may be triggered or activated by the companion UE 115-b to the XR device 205-b in a synchronized way, and this triggering may be shared with the XR device 205-b via the NB channel.

In some examples, the communication timeline 300 may include a first allocated duration of time duration 315-a. Additionally, or alternatively, the communication timeline 300 may include a second allocated duration of time duration 315-b. In some implementations, the companion UE 115-b and the XR device 205-b (e.g., a first UE-XR device pair) may perform sidelink communications (e.g., via the UWB sidelink connection 210 of the wireless communications system 200) within the first allocated duration of time duration 315-a and the second allocated duration of time duration 315-b. Additionally, or alternatively, the communication timeline 300 may include a duration 320, a duration 325, and a duration 330, which may be allocated for a second UE-XR device pair (e.g., UE-XR pair 2), a third UE-XR device pair (e.g., UE-XR pair 3), and a fourth UE-XR device pair (e.g., UE-XR pair 4), respectively (e.g., different UE-XR pairs than the companion UE 115-b and XR device 205-b device pair). In such examples, the companion UE 115-b and the XR device 205-b may refrain from communicating during the duration 320, the duration 325, and the duration 330.

In some examples, such as the communication timeline 300, the UE companion UE 115-b and may be synchronized based on a cellular network and may be a time and frequency synchronization master device for UWB sidelink communications. Correspondingly, the tethered with it XR device 205-b may align with the companion UE 115-b timing and frequency.

Due to a short link range that is addressed for UE-XR links over UWB (e.g., within a threshold distance, or up to 10 meters between the companion UE 115-b and the XR device 205-b, for example), both the companion UE 115-b and the tethered with it XR device 205-b may be nearby one or more other potentially collocated (e.g., within the same threshold distance) XR-UE pairs that may introduce a mutual interference. In some examples, these one or more XR-UE pairs may share similar timing synchronization if the devices are directly or indirectly synchronized on WWAN downlink reception timing and frequency (e.g., all collocated UE-XR pairs may be synchronized to WWAN DL reception up to some small timing uncertainty). In such examples, the collocated XR-UE pairs may be assigned with non-overlapping TD/FD resources (e.g., by the WWAN) for UWB communications to avoid mutual interference.

In some implementations, cellular-based reference clocks may be used for NB channel transmissions and for UWB transmissions from the companion UE 115-b to allow an indirect XR synchronization to cellular timeline (e.g., once the XR device 205-b is synchronized with the companion UE 115-b over the UWB sidelink). Correspondingly, the cellular network (e.g., WWAN) may coordinate FD/TD UWB resources selection for different UE-XR pairs based on the UE companion devices being connected to the WWAN. In such examples, resource configurations may be provided with respect to a cellular timeline (e.g., the shared timeline by all the collocated UE-XR pairs based on cellular downlink receptions). Accordingly, the assigned per UE-XR pair UWB resources may be configured first by the cellular network to the companion UE 115-b (e.g., via cellular downlink signaling) and the companion UE 115-b may forward this configuration (e.g., with a translation to a local timeline corresponding to the companion UE 115-b and the XR device 205-b) to the tethered XR device 205-b via the primary NB channel. For example, the UWP timeline may be shared between the UE 115-b an the XR device 205-b after NB assisted discovery, initial pairing, shared timing acquisition, and UWB configuration is completed. The UE 115-b may provide the required conversation or translation between the cellular timeline 305 and the UWB timeline to configure the XR device 205-b with the UWB resources over the NB channel.

In some implementations, the communication timeline 300 may include an initial pairing procedure 335. As described herein with respect to FIG. 2, the companion UE 115-b and the XR device 205-b may perform the initial pairing procedure 335 via a NB sidelink connection. The initial pairing procedure 335 may provide for initial device discovery, initial timing sharing, and initial resource acquisition (e.g., time resources and frequency resources) between the companion UE 115-b and the XR device 205-b. Additionally, or alternatively, the initial pairing procedure 335 may include configuring and establishing a UWB sidelink connection.

In some implementations, the companion UE 115-b and the XR device 205-b may perform UWB sidelink initial link establishment over a primary NB channel. In some cases, UWB signal bandwidth may be at least 500 MHz (e.g., based on UWB signal definitions). In such cases, it may be inefficient to use a relatively high bandwidth for a continuous transmission of initial channel access related transmissions. NB technologies (e.g., NB sidelinks) may use a relatively smaller signal bandwidth, and accordingly may be more efficient to perform initial pairing procedures (e.g., such as the initial pairing procedure 335) between XR and UE devices over the primary NB channel. The NB may also be used to continuously maintain a low-rate connection link as a primary connection mainly for configuration purposes, control purposes, coordination purposes, or any combination thereof between the companion UE 115-b and the XR device 205-b.

In some implementations, NB assisted UWB (NBA-UWB) may be based on offset quadrature phase-shift keying (O-QPSK PHY). The assisting NB channel (e.g., NBA-UWB) may be used for discovery, initial pairing, and control of UWB transmissions and the UWB channel, as well as initial acquisition of timing and frequency for UWB transmissions, which may be offloaded (e.g., based on) to the NB PHY. Additionally, or alternatively, a tight clock synchronization may be maintained between the NB and the UWB channels and transmissions. In such cases, both PHYs (e.g., NB PHY and UWB PHY) may be driven by the same clock reference such that both these channels may be fully synchronized.

In some implementations, a LBT mechanism may be used for the NB channel access to allow co-existence with other technologies (e.g., other devices utilizing the NB channel). The NB targeted frequencies may include 5725 MHz to 5850 MHz (e.g., UNII-3 band).

After the initial pairing procedure 335, the companion UE 115-b and the XR device 205-b may initiate a shared time counting. The shared time counting may begin at the start of UE-XR shared time counting 340. Additionally, or alternatively, the shared time counting may have a granularity (e.g., precision) such that the beginning of each allotted duration of time such as the first allocated duration of time duration 315-a or the second allocated duration of time duration 315-b, as well as corresponding UWB sidelink resources, may be indicated. Further, the communication timeline 300 may include a NB assisted triggering signal 345. As described herein with respect to FIG. 2, the companion UE 115-b may transmit the NB assisted triggering signal 345 via the NB sidelink connection and may initiate sidelink communications between the companion UE 115-b and the XR device 205-b via the UWB sidelink connection.

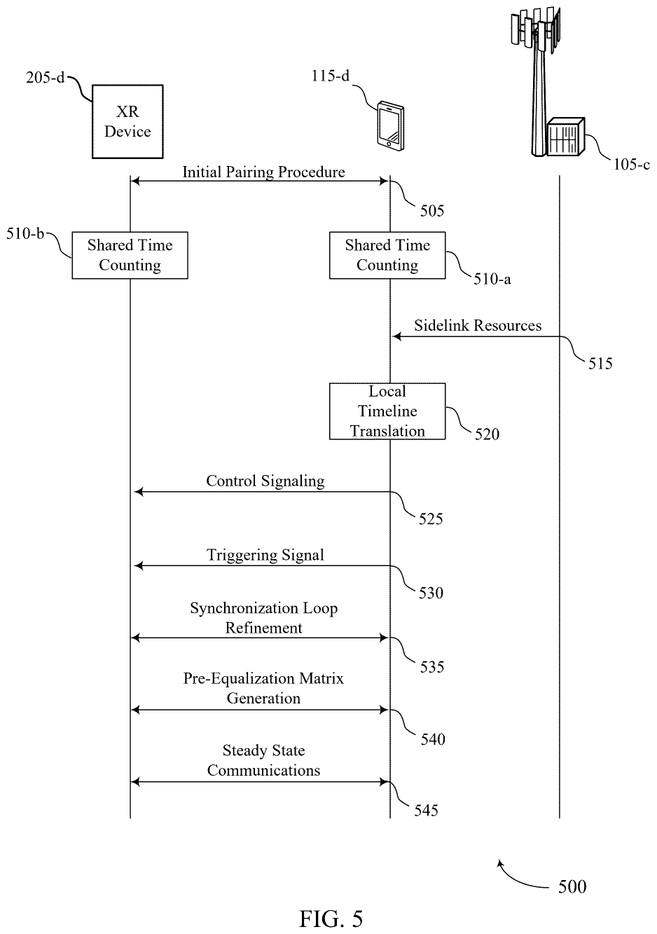

In some implementations, the communication timeline 300 may include an activation phase 350. The activation phase 350 may correspond to the first allocated duration of time duration 315-a. In some examples, the XR device 205-a may transmit a series of UL RS 355 to the companion UE 115-b. In some examples, the XR device 205-b may transmit multiple UL RS to achieve RS aggregation (e.g., a same UL RS may be repeated). Additionally, or alternatively, the companion UE 115-a may transmit one or more control signals 360 (e.g., sync loop correction messages) via one or more downlink control messages based on receiving the UL RS 355. In some examples further described herein with respect to FIG. 2, the one or more control signals 360 may indicate one or more frequency corrections, timing corrections (e.g., clock adjustments for the companion UE 115-b or XR device 205-b) or both based on one or more PPM TO errors, PPM FO errors, or both between the companion UE 115-b and the XR device 205-b. In some examples, where a channel reciprocity is present between the companion UE 115-b and the XR device 205-b, the XR device 205-b may additionally transmit an UL RS 365 to be used for determining a downlink equalization matrix. In some other examples further described herein with respect to FIGS. 2 and 5, the companion UE 115-b may alternatively transmit one or more non-equalized DL RS to be used by the companion UE 115-b and the XR device 205-b to determine the downlink equalization matrix.

The activation phase 350 may include a defined sequence of UL and DL reference signals. In the case of no reciprocity (e.g., channel reciprocity is not assumed), the XR device 205-b may transmit one or more UL RSs 355, which may be used for XR synchronization loop refinement. Multiple instances of the UL RSs 355 may be transmitted for aggregation at the UE 115-b. The UE 115-b may transmit synchronization loop correction information (e.g., via downlink control signaling, such as the control signals 360). The XR device 205-b may transmit one or more UL RSs 365 (e.g., for downlink equalization response evaluation). During or after the activation phase 350 (e.g., or during the steady state phase 375) the UE 115-b may transmit one or more steady state downlink (SS DL) signals 370 (e.g., pre-equalized downlink data via a downlink slot). In some examples (e.g., during or after the activation phase 350, or during the steady state phase 375), the XR device 205-b may transmit steady state uplink (SS UL) signals 380.

Based on performing the activation phase 350, including communicating the UL RS 355, the one or more control signals 360, and the UL RS 365, the companion UE 115-b and the XR device 205-b may begin steady state communications (e.g., other sidelink communications not used for initial activation such as data signals, resource allocations, or other communications), including the SS DL signals 370 and the SS UL signals 380. The communication timeline 300 includes a steady state phase 375, which may correspond to the second allocated duration of time duration 315-b. In some examples, the companion UE 115-b and the XR device 205-b may perform the activation procedure during the activation phase 350 (e.g., a first instance of the time duration 315-a allocated to the UE-XR pair 1 including the companion UE 115-b and the XR device 205-b), and may perform the steady state phase communications during a next available steady state phase 375 (e.g., a next available time duration 315-b allocated for the same UE-XR pair 1). In some examples, a steady state phase may be any allotted duration of time other than the activation phase 350. For example, when the link has reached the steady state where continuous data streamlining relying on transmission equalization (e.g., in case of DL signaling) takes place over the assigned resources by the cellular or network resources. In some examples, after reaching steady state, UL RSs 365, UL RSs 355, control signals 360, etc., may be embedded within the SS transmissions and thus not indicated on the SS phase.

As described herein with reference to FIG. 2, in some implementations, a network entity 105, a UE 115, and a XR device 205-a may communicate in accordance with the communication timeline 300 to establish sidelink communications via a UWB sidelink connection based on a NB sidelink connection initial procedure.

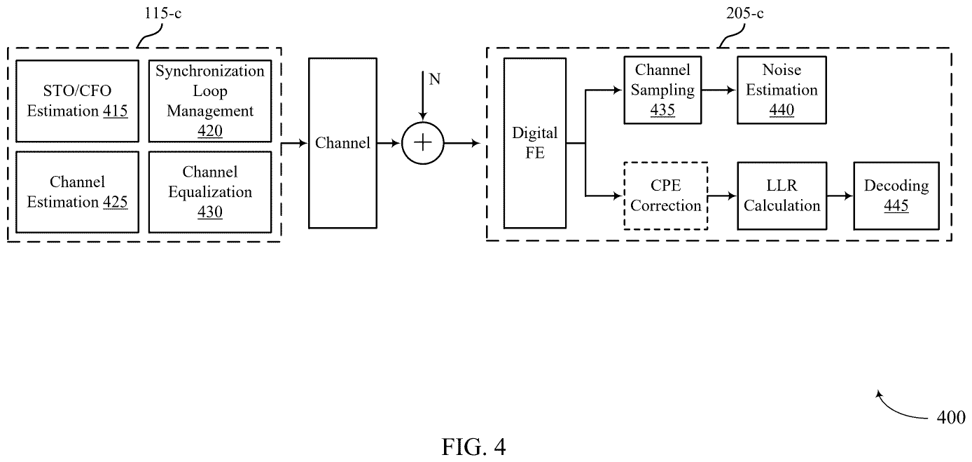

FIG. 4 shows an example of a system architecture 400 that supports link establishment procedures for UWB sidelinks in accordance with one or more aspects of the present disclosure. The system architecture 400 may implement or may be implemented by aspects of the wireless communications system 100 or the wireless communications system 200. For example, the system architecture 400 may include a companion UE 115-c and an XR device 205-c, which may be examples of a UE 115 and an XR device 205, respectively, as described with reference to FIGS. 1 and 2.

To allow for the XR device 205-c to operate as a mostly input-output (I/O) device, as described herein, complexity associated with the XR device 205-c transmitting or receiving signaling (e.g., including PHY layer or modem related complexity) may be shifted to (performed by) the companion UE 115-b. In some examples, the modem complexity may result from receiver-side processing (e.g., base band receiver-side processing). Accordingly, receiver PHY modules at the XR device 205-c may be effectively shifted to the transmission side of a UWB sidelink connection at the companion UE 115-c (e.g., and thus degenerated at the XR device 205-c). Thus, the XR device 205-c may operate with reduced processing and may accordingly achieve a reduced processing complexity and power consumption.

In some examples, a fast Fourier transform (FFT) complexity (e.g., and any receiver PHY modules associated with FFT) may be absent from the XR device 205-c. For example, the companion UE 115-c may transmit signals to the XR device 205-c via DFT-s-OFDM, and the XR device 205-a may refrain from performing some (e.g., any) FFT operations. Accordingly, the XR device 205-a may process data symbols on the receive-side via a time domain (e.g., as opposed to a frequency domain). In some cases, the XR device 205-c may support an FFT and DFT of a same size.

The XR device 205-c may lack PHY modules associated with STO or CFO estimation. Instead, the companion UE 115-c at the transmitter-side may include a STO/CFO estimation component 415. For example, the companion UE 115-c may, via the STO/CFO estimation component 415, perform CFO and STO estimation for the XR device 205-c (e.g., thereby shifting CFO/STO estimation from receiver-side to transmit-side). The companion UE 115-c may also include a synchronization loop management component 420, which the companion UE 115-c may use to perform synchronization loop management for the XR device 205-c (e.g., thereby shifting synchronization loop management from receiver-side to transmit-side). Using the synchronization loop management component 420 or the STO/CFO estimation component 415, or a combination thereof, the companion UE 115-c may transmit correction updates to the XR device 205-c (e.g., paired device), and the XR device 205-c may apply the correction updates locally.

In some examples, the companion UE 115-c may include a channel estimation component 425, which may perform channel estimation for the XR device 205-c (e.g., thereby shifting channel estimation from receive-side to transmit-side). In cases of non-reciprocal channels (e.g., FDD, SBFD), the XR device 205-c may include the channel sampling component 435, and channel estimation may be distributed between the XR device 205-c at the receive-side, and the companion UE 115-c at the transmit-side. In such cases, the XR device 205-c may use the channel estimation component 425 to indicate samples to the companion UE 115-b. In cases of reciprocal channels (e.g., full duplex, TDD), the XR device 205-c may not include the channel sampling component 435, and the channel estimation component 425 at the companion UE 115-c may perform channel estimation for the XR device 205-c (e.g., without sampling at the XR device 205-c).

The XR device 205-c may include a noise estimation component 440. The XR device 205-c may utilize the noise estimation component 440 to indicate receiver-side noise statistics (Rnn) or noise variance to the companion UE 115-b. The companion UE 115-c may use the indicated Rnn or noise variance from the XR device 205-c for transmit precoding. Because the XR device 205-c lacks a channel equalization component (e.g., with channel equalization shifted to transmit-side at the companion UE 115-b), the XR device 205-c may be unable to perform channel whitening or interference rejection combining (IRC). The companion UE 115-c may include a channel equalization component 430 and may perform space-frequency equalization for the XR device 205-c (e.g., thereby shifting channel equalization from receive-side to transmit-side). For example, using the channel equalization component 430, the companion UE 115-c may perform one or more of throughput (THP) calculation, linear transmit-side filtering, precoding, or other channel equalization procedures associated with the XR device 205-c.

The XR device 205-c may include a decoding component 445. The XR device 205-c may use a low complexity decoding scheme for decoding signals (e.g., from the companion UE 115-b), which may reduce a complexity or a processing power associated with the decoding component 445.

Techniques described herein with respect to FIG. 2 may enable the companion UE 115-c and the XR device 205-c to establish a UWB sidelink connection via a NB sidelink connection. Additionally, or alternatively, XR device 205-c may shift computation complexity to the companion UE 115-c via the UWB sidelink connection in accordance with techniques described herein.

FIG. 5 shows an example of a process flow 500 that supports link establishment procedures for UWB sidelinks in accordance with one or more aspects of the present disclosure. The process flow 500 may include a companion UE 115-d, a network entity 105-c, and a XR device 205-d, which may be respective examples of UE 115, network entity 105, and XR device 205 as described with reference to FIGS. 1 and 2.

At 505, the companion UE 115-d and the XR device 205-d may perform an initial pairing procedure via a NB sidelink connection. In some implementations, the initial pairing procedure may include initial device discovery, initial timing sharing, and initial resource acquisition (e.g., time resources and frequency resources) between the companion UE 115-d and the XR device 205-d. Additionally, or alternatively, the initial pairing procedure may configure and establish a UWB sidelink connection.

At 510-a and 510-b, the companion UE 115-d and the XR device 205-d may initiate shared time counting. In some implementations, the companion UE 115-d and the XR device 205-d may initiate the shared time counting by communicating one or more timeline synchronization messages via the NB sidelink connection until a time accuracy between the companion UE 115-d and the XR device 205-d satisfies a threshold (e.g., is within an accuracy tolerance). Additionally, or alternatively, the companion UE 115-d and the XR device 205-d may maintain the shared time counting in accordance with a local timeline for sidelink communications. In some examples, the shared time counting may be based on one or more cellular reference clock signals.

At 515, the network entity 105-c may transmit an indication of one or more sidelink resources to the companion UE 115-d. In some examples, the one or more sidelink resources may correspond to a cellular timeline (e.g., may have time resources defined in reference to a cellular timeline for communications). The one or more sidelink resources may correspond to an allotted duration of time for sidelink communications (e.g., according to and scheduled by the cellular timeline). In some examples, the one or more sidelink resources and the allotted duration of time may correspond to a periodic communication pattern (e.g., as illustrated with reference to FIG. 3). The periodic communication pattern may represent a time-domain resource grid according to the cellular timeline (e.g., a repeating pattern of allotted time resource in terms of the cellular timeline).

At 520, the companion UE 115-d may translate the one or more resources to correspond to the local timeline for sidelink communications (e.g., the timeline maintained by the companion UE 115-d and the XR device 205-d). As such, the translated resources for sidelink communications may additionally correspond to an allotted duration of time for sidelink communications according to the local timeline. Additionally, or alternatively, at 525, the companion UE 115-d may transmit control signaling to the XR device 205-d indicating the one or more sidelink resources according to the local timeline via the NB sidelink connection (e.g., the indication of the one or more sidelink resources may be forwarded from the network entity 105-c to the XR device 205-d with some translation).

At 530, the companion UE 115-d may transmit a triggering signal to the XR device 205-d via the NB sidelink connection. The triggering signal may initiate sidelink communications between the companion UE 115-d and the XR device 205-d via the UWB sidelink connection. In some implementations, the sidelink communications may begin at a first available time according to the local timeline (e.g., within the first allotted duration of time. The triggering may activate semi-persistent communications (e.g., sidelink communications) between the companion UE 115-d and the XR device 205-d (e.g., the sidelink communication may continue for some duration of time without retransmitting the triggering signal).

At 535, the companion UE 115-d and the XR device 205-d may perform an initial synchronization loop refinement procedure via the UWB sidelink connection. In some implementations, the synchronization loop refinement procedure may include a time synchronization and a frequency synchronization between the companion UE 115-d and the XR device 205-d. In some examples, the companion UE 115-d and the XR device 205-d may determine one or more resource offset values (e.g., FO, TO, or both) based on one or more PPM error measurements associated with communications via the UWB sidelink connection. In such examples, the companion UE 115-d and the XR device 205-d may perform a frequency correction (e.g., based on a FO PPM error value), a timing correction including updating one or more local clocks of the companion UE 115-d and the XR device 205-d (e.g., a local oscillator, a phase lock loop (PLL), a clock synthesizer, or other clock sources) or both. Additionally, or alternatively, the companion UE 115-d and the XR device 205-d may repeat the synchronization loop refinement procedure one or more times until an accuracy threshold is satisfied (e.g., until the one or more resource offset values are within an accuracy tolerance value based on applying the frequency and timing corrections). Communications via the UWB may rely on synchronization updates aligned to transmission equalization updates (e.g., but not in the middle of transmission equalization refresh periods, to maintain channel coherence and alignment to a currently used transmission equalization response). In some examples, synchronization reference signals may be used for distributed synchronization loop adjustments and tracking (e.g., PPM errors, FOs, and TOs, time counting tracking, etc.), for the XR device 205-d. The UE 115-d may derive and signal to the XR device 205-d synchronization loops corrections to be applied locally at the XR device 205-d based on UL RSs transmitted by the XR device 205-d. This sync loop corrections indication may be provided over the NB channel, or directly over the UWB channel. PPM errors or FO tracking may be impacted as time drifts (e.g., as a shared counting drifts or changes). Residual TO corrections may be accomplished coupled with transmission equalization updates. DL TO estimation may be based on DL RSs. Transmission equalization data transmission may be initiated when synchronization loops fully converge to a required accuracy (e.g., a steady state).

At 540, the companion UE 115-d and the XR device 205-d may perform a pre-equalization matrix generation procedure via the UWB sidelink connection (e.g., to support quasi-continuous CSI for the UWB channel). The pre-equalization matrix procedure may implement or otherwise support the techniques described herein with respect to FIG. 4 to shift computation complexity (e.g., pre-equalization matrix generation) to the companion UE 115-d via the UWB sidelink connection.

The pre-equalization matrix generation procedure may be based on a channel reciprocity state (e.g., channel reciprocity for uplink and downlink channels between the companion UE 115-d and the XR device 205-d being present or absent). For example, a channel reciprocity may be present between the companion UE 115-d and the XR device 205-d (e.g., an UL channel and a DL channel of the UWB sidelink connection may be quasi co-located (QCL)). In such examples, the XR device 205-d may transmit one or more UL RS (e.g., pilot signals) via an UL channel of the UWB sidelink connection. Additionally, or alternatively, the companion UE 115-d may estimate (e.g., directly estimate one or more characteristics of) a DL channel of the UWB sidelink connection based on receiving the UL RS. In such examples, the companion UE 115-d may determine one or more equalization matrices for sidelink communications based on receiving the UL RS and estimating the DL channel.

In some other examples, a channel reciprocity between the companion UE 115-d and the XR device 205-d may be absent. In such examples, the companion UE 115-d may transmit one or more non-equalized DL RS (DL RS) (e.g., DL RS not adjusted according to one or more characteristics of the downlink channel). The XR device 205-d may receive the DL RS and sample the DL RS (e.g., quantize and compress the DL RS). Additionally, or alternatively, the XR device 205-d may transmit an indication of the sampled DL RS to the companion UE 115-d, and the companion UE 115-d may estimate (e.g., estimate one or more characteristics of) the DL channel based on receiving the sampled DL RS. In such examples, the companion UE 115-d may determine one or more equalization matrices for sidelink communications based on receiving the sampled DL RS and estimating the DL channel.

At 545, the companion UE 115-d and the XR device 205-d may perform steady state sidelink communications. The steady state sidelink communications may continue semi-persistently (e.g., continuously) within allocated durations of time. Additionally, or alternatively, the companion UE 115-d and the XR device 205-d may repeat the synchronization loop refinement procedure, the pre-equalization matrix generation procedure, or both periodically based on one or more parameters, or to satisfy one or more accuracy or performance thresholds.

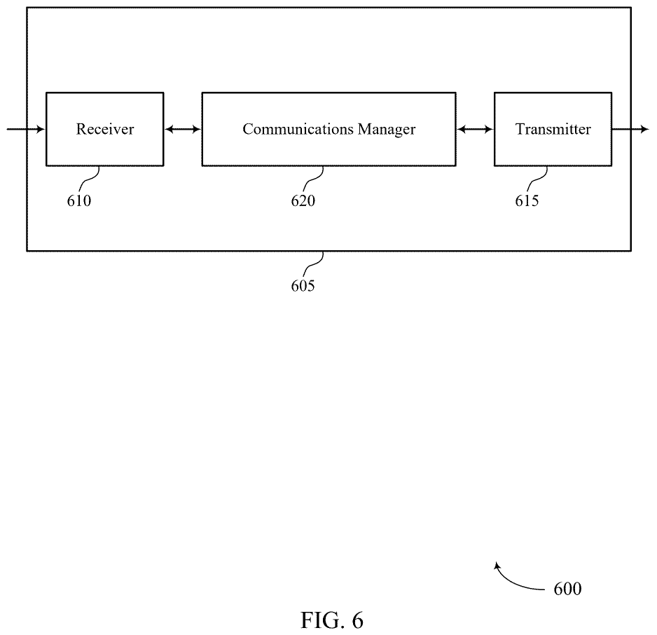

FIG. 6 shows a block diagram 600 of a device 605 that supports link establishment procedures for UWB sidelinks in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to link establishment procedures for UWB sidelinks). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to link establishment procedures for UWB sidelinks). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of link establishment procedures for UWB sidelinks as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for performing an initial pairing procedure with an extended reality device via a narrow band, where the initial pairing procedure establishes an UWB sidelink connection between the UE and the extended reality device. The communications manager 620 is capable of, configured to, or operable to support a means for transmitting control signaling via the narrow band indicating one or more sidelink resources of the UWB sidelink connection for the extended reality device, where a local timeline for sidelink communications between the UE and the extended reality device associated with the one or more sidelink resources is translated from cellular timeline corresponding to the UWB sidelink connection. The communications manager 620 is capable of, configured to, or operable to support a means for transmitting a triggering signal, via the narrow band, initiating sidelink communications between the UE and the extended reality device via the one or more sidelink resources of the UWB sidelink connection, the sidelink communications satisfying the local timeline according to the translation from the cellular timeline.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for reduced processing and reduced power consumption, among other benefits

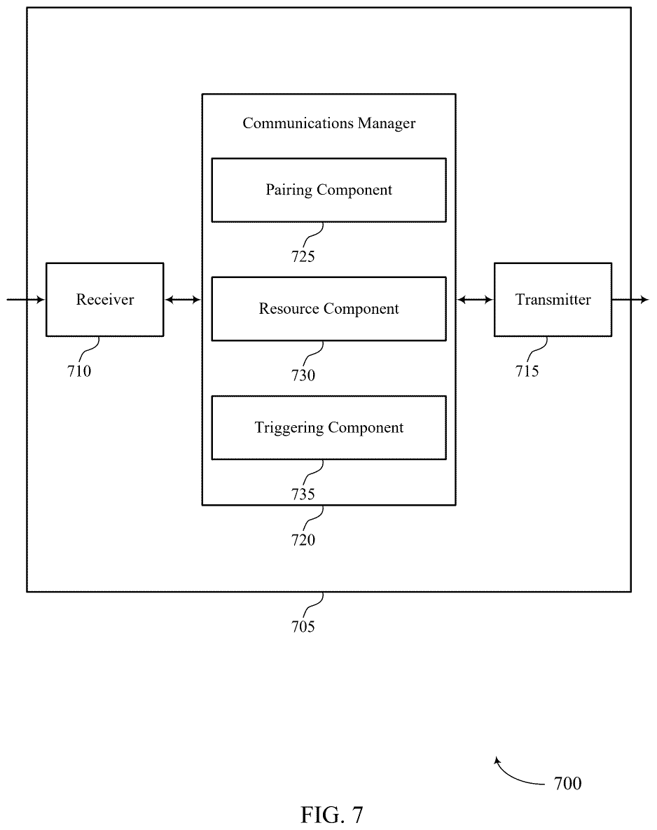

FIG. 7 shows a block diagram 700 of a device 705 that supports link establishment procedures for UWB sidelinks in accordance with one or more aspects of the present disclosure. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to link establishment procedures for UWB sidelinks). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to link establishment procedures for UWB sidelinks). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of link establishment procedures for UWB sidelinks as described herein. For example, the communications manager 720 may include a pairing component 725, a resource component 730, a triggering component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The pairing component 725 is capable of, configured to, or operable to support a means for performing an initial pairing procedure with an extended reality device via a narrow band, where the initial pairing procedure establishes an UWB sidelink connection between the UE and the extended reality device. The resource component 730 is capable of, configured to, or operable to support a means for transmitting control signaling via the narrow band indicating one or more sidelink resources of the UWB sidelink connection for the extended reality device, where a local timeline for sidelink communications between the UE and the extended reality device associated with the one or more sidelink resources is translated from cellular timeline corresponding to the UWB sidelink connection. The triggering component 735 is capable of, configured to, or operable to support a means for transmitting a triggering signal, via the narrow band, initiating sidelink communications between the UE and the extended reality device via the one or more sidelink resources of the UWB sidelink connection, the sidelink communications satisfying the local timeline according to the translation from the cellular timeline.

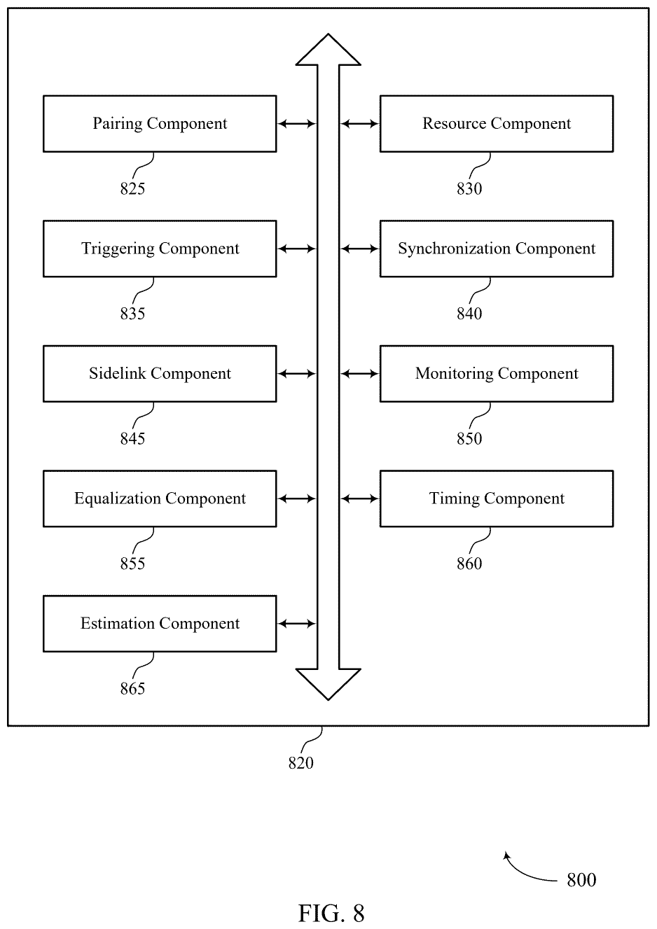

FIG. 8 shows a block diagram 800 of a communications manager 820 that supports link establishment procedures for UWB sidelinks in accordance with one or more aspects of the present disclosure. The communications manager 820 may be an example of aspects of a communications manager 620, a communications manager 720, or both, as described herein. The communications manager 820, or various components thereof, may be an example of means for performing various aspects of link establishment procedures for UWB sidelinks as described herein. For example, the communications manager 820 may include a pairing component 825, a resource component 830, a triggering component 835, a synchronization component 840, a sidelink component 845, a monitoring component 850, an equalization component 855, a timing component 860, an estimation component 865, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The pairing component 825 is capable of, configured to, or operable to support a means for performing an initial pairing procedure with an extended reality device via a narrow band, where the initial pairing procedure establishes an UWB sidelink connection between the UE and the extended reality device. The resource component 830 is capable of, configured to, or operable to support a means for transmitting control signaling via the narrow band indicating one or more sidelink resources of the UWB sidelink connection for the extended reality device, where a local timeline for sidelink communications between the UE and the extended reality device associated with the one or more sidelink resources is translated from cellular timeline corresponding to the UWB sidelink connection. The triggering component 835 is capable of, configured to, or operable to support a means for transmitting a triggering signal, via the narrow band, initiating sidelink communications between the UE and the extended reality device via the one or more sidelink resources of the UWB sidelink connection, the sidelink communications satisfying the local timeline according to the translation from the cellular timeline.

In some examples, the resource component 830 is capable of, configured to, or operable to support a means for receiving, from a network entity, an indication of a set of multiple resources corresponding to the cellular timeline, the set of multiple resources including the one or more sidelink resources. In some examples, the resource component 830 is capable of, configured to, or operable to support a means for translating the set of multiple resources corresponding to the cellular timeline into the one or more sidelink resources that correspond to the local timeline for sidelink communications, where transmitting the control signaling indicating the one or more sidelink resources is based on the translation.

In some examples, the set of multiple resources are allocated for sidelink communications between the UE and the extended reality device according to a periodic communication pattern. In some examples, the periodic communication pattern includes a time-domain resource grid according to the cellular timeline.

In some examples, a first set of time durations of the periodic communication pattern correspond to the UE and the extended reality device, and a second set of time durations of the periodic communication pattern correspond to a second UE and a second extended reality device.

In some examples, the synchronization component 840 is capable of, configured to, or operable to support a means for performing, during a first available duration of time allocated to the UE and the extended reality device according to the local timeline, a synchronization loop procedure via the UWB sidelink connection based on transmitting the triggering signal, where the synchronization loop procedure includes a time synchronization and a frequency synchronization between the UE and the extended reality device. In some examples, the sidelink component 845 is capable of, configured to, or operable to support a means for communicating, during one or more second available durations of time allocated to the UE and the extended reality device according to the local timeline, one or more steady state sidelink communications between the UE and the extended reality device, where the one or more second available durations of time occur subsequent to the first available duration of time.

In some examples, to support synchronization loop procedure, the synchronization component 840 is capable of, configured to, or operable to support a means for receiving one or more first uplink reference signals. In some examples, to support synchronization loop procedure, the synchronization component 840 is capable of, configured to, or operable to support a means for transmitting one or more downlink reference signals in accordance with a loop refinement procedure based on the one or more first uplink reference signals. In some examples, to support synchronization loop procedure, the synchronization component 840 is capable of, configured to, or operable to support a means for receiving one or more second uplink reference signals based on transmitting the one or more downlink reference signals. In some examples, to support synchronization loop procedure, the equalization component 855 is capable of, configured to, or operable to support a means for performing a downlink equalization response evaluation procedure based on receiving the one or more second uplink reference signals, one or more synchronization loop corrections via downlink control signaling, or a combination thereof.

In some examples, to support time synchronization, the timing component 860 is capable of, configured to, or operable to support a means for communicating a timeline synchronization message via the narrow band. In some examples, to support time synchronization, the timing component 860 is capable of, configured to, or operable to support a means for recommunicating the timeline synchronization message via the narrow band one or more times based on satisfying a timeline accuracy threshold.

In some examples, the synchronization component 840 is capable of, configured to, or operable to support a means for repeating the synchronization loop procedure one or more times until one or more accuracy thresholds are satisfied.

In some examples, the sidelink communications are activated semi-persistently based on the triggering signal and in accordance with the local timeline.

In some examples, performing the initial pairing procedure is based on a successful listen-before-talk procedure.

In some examples, the sidelink component 845 is capable of, configured to, or operable to support a means for sending one or more first transmissions via the one or more sidelink resources of the UWB sidelink connection according to the local timeline. In some examples, the monitoring component 850 is capable of, configured to, or operable to support a means for monitoring for one or more second transmissions via the one or more sidelink resources of the UWB sidelink connection according to the local timeline. In some examples, the triggering component 835 is capable of, configured to, or operable to support a means for retransmitting the triggering signal based on the monitoring.

In some examples, the equalization component 855 is capable of, configured to, or operable to support a means for generating a pre-equalization matrix the sidelink communications based on a channel reciprocity state.

In some examples, to support generating the pre-equalization matrix, the estimation component 865 is capable of, configured to, or operable to support a means for receiving one or more uplink channel estimation reference signals via an uplink channel, the uplink channel corresponding to the UWB sidelink connection. In some examples, to support generating the pre-equalization matrix, the estimation component 865 is capable of, configured to, or operable to support a means for performing an estimation of one or more characteristics of a downlink channel based on receiving the one or more uplink channel estimation reference signals. In some examples, to support generating the pre-equalization matrix, the sidelink component 845 is capable of, configured to, or operable to support a means for performing the sidelink communications according to one or more equalization matrices based on performing an evaluation of the one or more equalization matrices and based on a channel reciprocity according to the channel reciprocity state.

In some examples, to support generating the pre-equalization matrix, the estimation component 865 is capable of, configured to, or operable to support a means for transmitting one or more non-equalized downlink reference signals via a downlink channel, the downlink channel corresponding to the UWB sidelink connection. In some examples, to support generating the pre-equalization matrix, the estimation component 865 is capable of, configured to, or operable to support a means for receiving, in a next available uplink slot according to the local timeline, an indication of one or more samples of the one or more non-equalized downlink reference signals. In some examples, to support generating the pre-equalization matrix, the estimation component 865 is capable of, configured to, or operable to support a means for performing an estimation of one or more characteristics of the downlink channel based on receiving the indication. In some examples, to support generating the pre-equalization matrix, the sidelink component 845 is capable of, configured to, or operable to support a means for performing the sidelink communications according to one or more equalization matrices based on performing an evaluation of the one or more equalization matrices and based on a lack of channel reciprocity according to the channel reciprocity state.

In some examples, the timing component 860 is capable of, configured to, or operable to support a means for receiving, from a network entity, one or more reference clock signals, where the one or more reference clock signals are based on the cellular timeline, and where the extended reality device is synchronized with the cellular timeline based on the one or more reference clock signals.

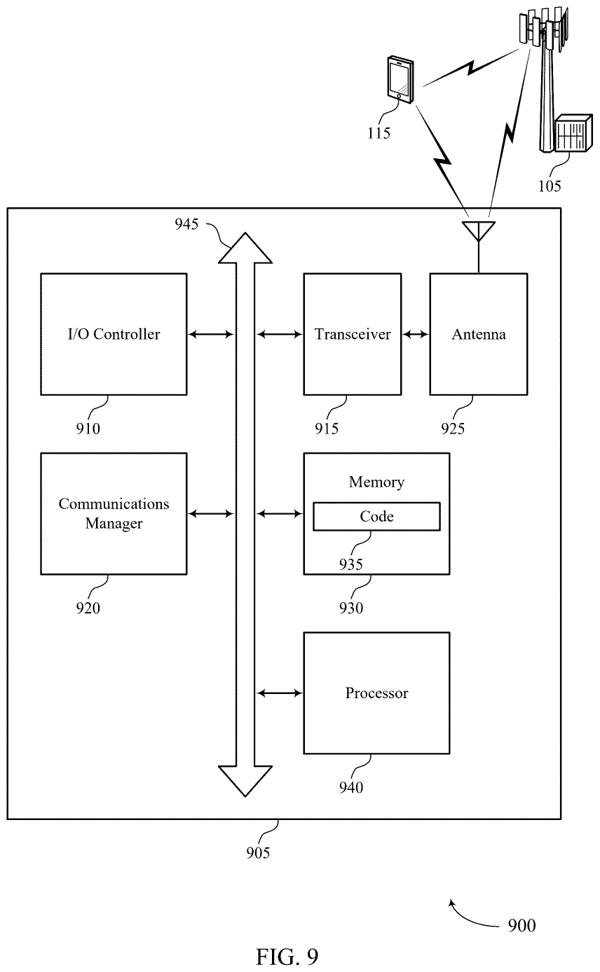

FIG. 9 shows a diagram of a system 900 including a device 905 that supports link establishment procedures for UWB sidelinks in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting link establishment procedures for UWB sidelinks). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for performing an initial pairing procedure with an extended reality device via a narrow band, where the initial pairing procedure establishes an UWB sidelink connection between the UE and the extended reality device. The communications manager 920 is capable of, configured to, or operable to support a means for transmitting control signaling via the narrow band indicating one or more sidelink resources of the UWB sidelink connection for the extended reality device, where a local timeline for sidelink communications between the UE and the extended reality device associated with the one or more sidelink resources is translated from cellular timeline corresponding to the UWB sidelink connection. The communications manager 920 is capable of, configured to, or operable to support a means for transmitting a triggering signal, via the narrow band, initiating sidelink communications between the UE and the extended reality device via the one or more sidelink resources of the UWB sidelink connection, the sidelink communications satisfying the local timeline according to the translation from the cellular timeline.

By including or configuring the communications manager 920 in accordance with examples as described herein, the device 905 may support techniques for reduced processing, reduced power consumption, improved coordination between devices, and longer battery life, among other benefits.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of link establishment procedures for UWB sidelinks as described herein, or the at least one processor 940 and the at least one memory 930 may be otherwise configured to, individually or collectively, perform or support such operations.

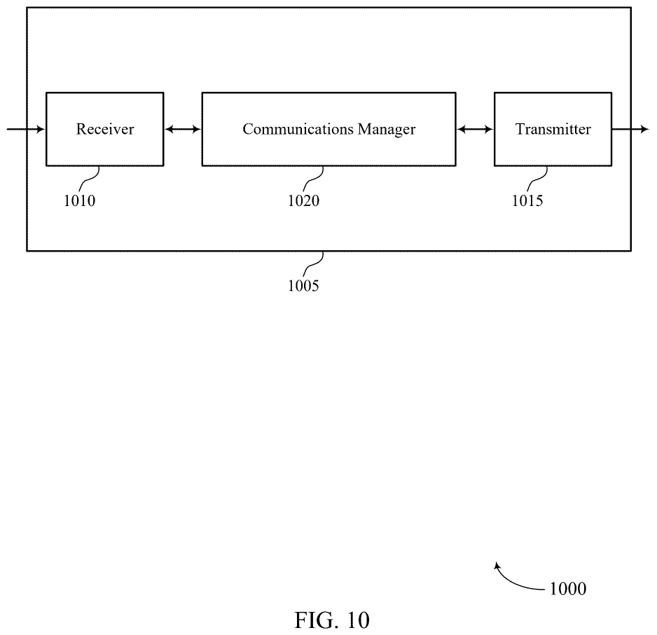

FIG. 10 shows a block diagram 1000 of a device 1005 that supports link establishment procedures for UWB sidelinks in accordance with one or more aspects of the present disclosure. The device 1005 may be an example of aspects of an XR device as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations or components thereof may be examples of means for performing various aspects of link establishment procedures for UWB sidelinks as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor (e.g., referred to as a processor-executable code). If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. For example, the communications manager 1020 is capable of, configured to, or operable to support a means for performing an initial pairing procedure with an extended reality device via a narrow band, where the initial pairing procedure establishes an UWB sidelink connection between a UE and the extended reality device. The communications manager 1020 is capable of, configured to, or operable to support a means for receiving control signaling via the narrow band indicating one or more sidelink resources of the UWB sidelink connection for the extended reality device, where a local timeline for sidelink communications between the UE and the extended reality device associated with the one or more sidelink resources is translated from cellular timeline corresponding to the UWB sidelink connection. The communications manager 1020 is capable of, configured to, or operable to support a means for receiving a triggering signal, via the narrow band, initiating sidelink communications between the UE and the extended reality device via the one or more sidelink resources of the UWB sidelink connection, the sidelink communications satisfying the local timeline according to the translation from the cellular timeline.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for may support techniques for reduced processing, reduced power consumption, improved coordination between devices, and longer battery life, among other benefits.

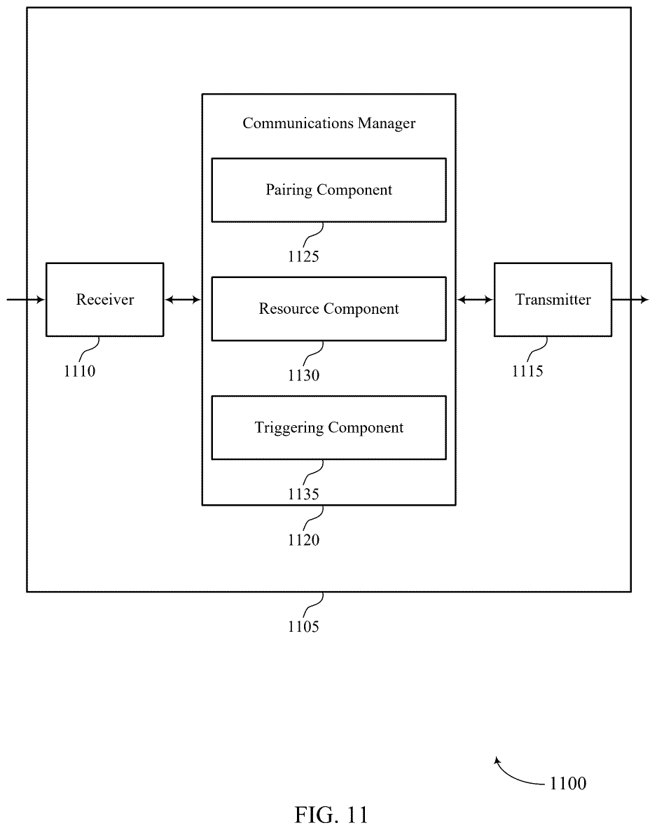

FIG. 11 shows a block diagram 1100 of a device 1105 that supports link establishment procedures for UWB sidelinks in accordance with one or more aspects of the present disclosure. The device 1105 may be an example of aspects of a device 1005 or an XR device 205-a as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of link establishment procedures for UWB sidelinks as described herein. For example, the communications manager 1120 may include a pairing component 1125, a resource component 1130, a triggering component 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. The pairing component 1125 is capable of, configured to, or operable to support a means for performing an initial pairing procedure with an extended reality device via a narrow band, where the initial pairing procedure establishes an UWB sidelink connection between a UE and the extended reality device. The resource component 1130 is capable of, configured to, or operable to support a means for receiving control signaling via the narrow band indicating one or more sidelink resources of the UWB sidelink connection for the extended reality device, where a local timeline for sidelink communications between the UE and the extended reality device associated with the one or more sidelink resources is translated from cellular timeline corresponding to the UWB sidelink connection. The triggering component 1135 is capable of, configured to, or operable to support a means for receiving a triggering signal, via the narrow band, initiating sidelink communications between the UE and the extended reality device via the one or more sidelink resources of the UWB sidelink connection, the sidelink communications satisfying the local timeline according to the translation from the cellular timeline.

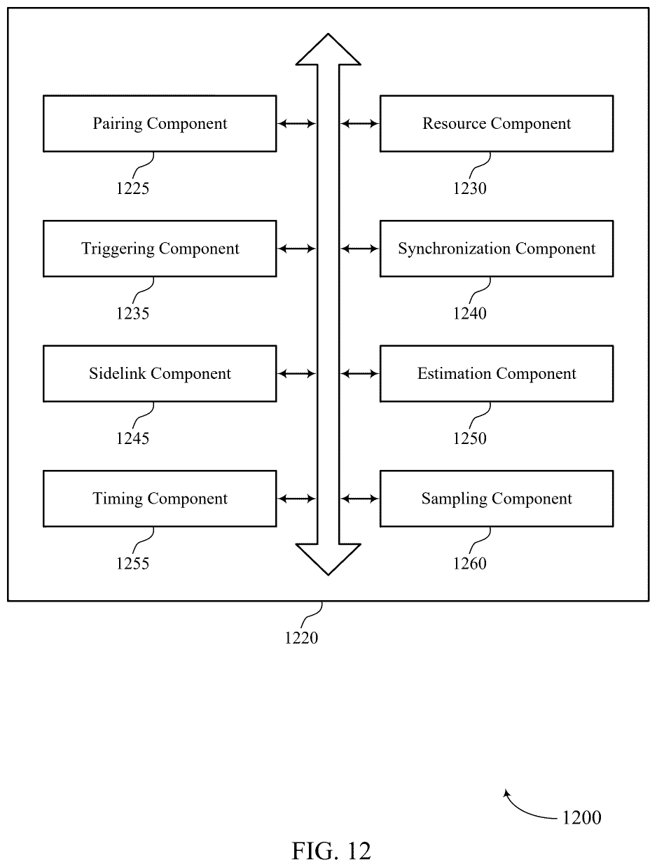

FIG. 12 shows a block diagram 1200 of a communications manager 1220 that supports link establishment procedures for UWB sidelinks in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of link establishment procedures for UWB sidelinks as described herein. For example, the communications manager 1220 may include a pairing component 1225, a resource component 1230, a triggering component 1235, a synchronization component 1240, a sidelink component 1245, an estimation component 1250, a timing component 1255, a sampling component 1260, or any combination thereof. Each of these components, or components or subcomponents thereof (e.g., one or more processors, one or more memories), may communicate, directly or indirectly, with one another (e.g., via one or more buses).

The communications manager 1220 may support wireless communications in accordance with examples as disclosed herein. The pairing component 1225 is capable of, configured to, or operable to support a means for performing an initial pairing procedure with an extended reality device via a narrow band, where the initial pairing procedure establishes an UWB sidelink connection between a UE and the extended reality device. The resource component 1230 is capable of, configured to, or operable to support a means for receiving control signaling via the narrow band indicating one or more sidelink resources of the UWB sidelink connection for the extended reality device, where a local timeline for sidelink communications between the UE and the extended reality device associated with the one or more sidelink resources is translated from cellular timeline corresponding to the UWB sidelink connection. The triggering component 1235 is capable of, configured to, or operable to support a means for receiving a triggering signal, via the narrow band, initiating sidelink communications between the UE and the extended reality device via the one or more sidelink resources of the UWB sidelink connection, the sidelink communications satisfying the local timeline according to the translation from the cellular timeline.

In some examples, the synchronization component 1240 is capable of, configured to, or operable to support a means for performing, during a first available duration of time allocated to the UE and the extended reality device according to the local timeline, a synchronization loop procedure via the UWB sidelink connection based on receiving the triggering signal, where the synchronization loop procedure includes a time synchronization and a frequency synchronization between the UE and the extended reality device. In some examples, the sidelink component 1245 is capable of, configured to, or operable to support a means for communicating, during one or more second available durations of time allocated to the UE and the extended reality device according to the local timeline, one or more steady state sidelink communications between the UE and the extended reality device, where the one or more second available durations of time occur subsequent to the first available duration of time.

In some examples, to support synchronization loop procedure, the synchronization component 1240 is capable of, configured to, or operable to support a means for transmitting one or more first uplink reference signals. In some examples, to support synchronization loop procedure, the synchronization component 1240 is capable of, configured to, or operable to support a means for receiving one or more downlink reference signals in accordance with a loop refinement procedure based on the one or more first uplink reference signals. In some examples, to support synchronization loop procedure, the synchronization component 1240 is capable of, configured to, or operable to support a means for transmitting one or more second uplink reference signals based on transmitting the one or more downlink reference signals.

In some examples, to support time synchronization, the timing component 1255 is capable of, configured to, or operable to support a means for communicating a timeline synchronization message via the narrow band. In some examples, to support time synchronization, the timing component 1255 is capable of, configured to, or operable to support a means for recommunicating the timeline synchronization message via the narrow band one or more times based on satisfying a timeline accuracy threshold.

In some examples, the synchronization component 1240 is capable of, configured to, or operable to support a means for repeating the synchronization loop procedure one or more times until one or more accuracy thresholds are satisfied.

In some examples, the sidelink communications are activated semi-persistently based on the triggering signal and in accordance with the local timeline.

In some examples, performing the initial pairing procedure is based on a successful listen-before-talk procedure.

In some examples, the estimation component 1250 is capable of, configured to, or operable to support a means for generating a pre-equalization matrix for the sidelink communications based on a channel reciprocity state.

In some examples, to support generating the pre-equalization matrix, the estimation component 1250 is capable of, configured to, or operable to support a means for transmitting one or more uplink channel estimation reference signals via an uplink channel, the uplink channel corresponding to the UWB sidelink connection. In some examples, to support generating the pre-equalization matrix, the estimation component 1250 is capable of, configured to, or operable to support a means for performing the sidelink communications according to the pre-equalization matrix based on transmitting the one or more uplink channel estimation reference signals and based on a channel reciprocity according to the channel reciprocity state.

In some examples, to support generating the pre-equalization matrix, the estimation component 1250 is capable of, configured to, or operable to support a means for receiving one or more non-equalized downlink reference signals via a downlink channel based on an absence of a channel reciprocity according to the channel reciprocity state, the downlink channel corresponding to the UWB sidelink connection. In some examples, to support generating the pre-equalization matrix, the sampling component 1260 is capable of, configured to, or operable to support a means for sampling the one or more non-equalized downlink reference signals. In some examples, to support generating the pre-equalization matrix, the sampling component 1260 is capable of, configured to, or operable to support a means for transmitting, in a next available uplink slot according to the local timeline, an indication of one or more samples of the one or more non-equalized downlink reference signals. In some examples, to support generating the pre-equalization matrix, the sidelink component 1245 is capable of, configured to, or operable to support a means for performing the sidelink communications according to the pre-equalization matrix based on sampling the one or more non-equalized downlink reference signals and based on a lack of channel reciprocity according to the channel reciprocity state.

In some examples, the timing component 1255 is capable of, configured to, or operable to support a means for receiving one or more reference clock signals, where the one or more reference clock signals are based on the cellular timeline, and where the extended reality device is synchronized with the cellular timeline based on the one or more reference clock signals.

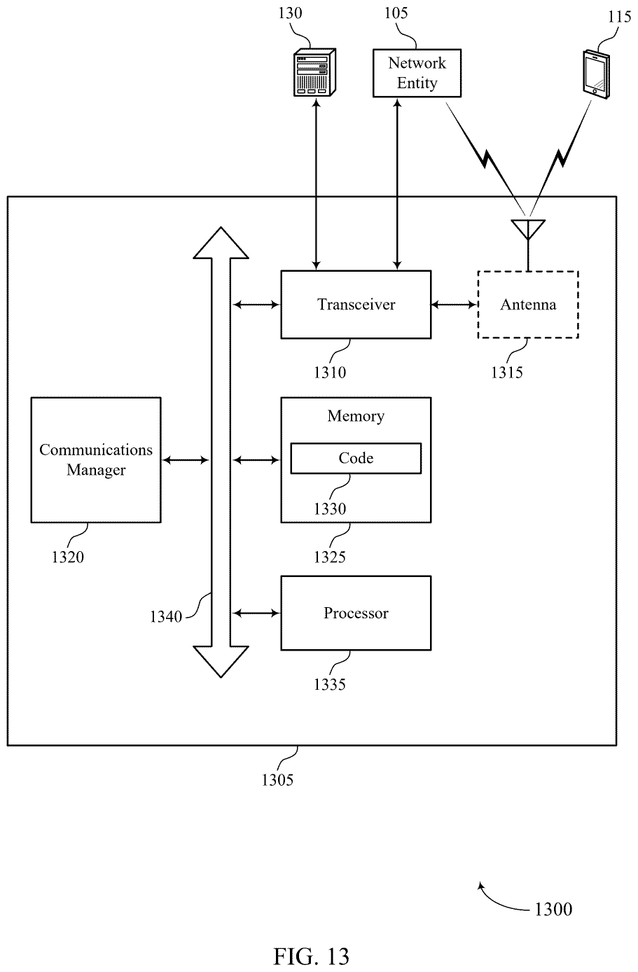

FIG. 13 shows a diagram of a system 1300 including a device 1305 that supports link establishment procedures for UWB sidelinks in accordance with one or more aspects of the present disclosure. The device 1305 may be an example of or include components of a device 1005, a device 1105, or an XR device as described herein. The device 1305 may include components for bi-directional voice and data communications including components for transmitting and receiving communications, such as a communications manager 1320, a transceiver 1310, one or more antennas 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., communication link(s) 125, backhaul communication link(s) 120, a midhaul communication link 162, a fronthaul communication link 168).

The at least one memory 1325 may include RAM, ROM, or any combination thereof. The at least one memory 1325 may store computer-readable, computer-executable, or processor-executable code, such as the code 1330. The code 1330 may include instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may include, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting link establishment procedures for UWB sidelinks). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325).

In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. For example, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with one or more other network entities 105, and may include a controller or scheduler for controlling communications with UEs 115 (e.g., in cooperation with the one or more other network devices). In some examples, the communications manager 1320 may support an X2 interface within an LTE/LTE-A wireless communications network technology to provide communication between network entities 105.

The communications manager 1320 may support wireless communications in accordance with examples as disclosed herein. For example, the communications manager 1320 is capable of, configured to, or operable to support a means for performing an initial pairing procedure with an extended reality device via a narrow band, where the initial pairing procedure establishes an UWB sidelink connection between a UE and the extended reality device. The communications manager 1320 is capable of, configured to, or operable to support a means for receiving control signaling via the narrow band indicating one or more sidelink resources of the UWB sidelink connection for the extended reality device, where a local timeline for sidelink communications between the UE and the extended reality device associated with the one or more sidelink resources is translated from cellular timeline corresponding to the UWB sidelink connection. The communications manager 1320 is capable of, configured to, or operable to support a means for receiving a triggering signal, via the narrow band, initiating sidelink communications between the UE and the extended reality device via the one or more sidelink resources of the UWB sidelink connection, the sidelink communications satisfying the local timeline according to the translation from the cellular timeline.

By including or configuring the communications manager 1320 in accordance with examples as described herein, the device 1305 may support techniques for may support techniques for reduced processing, reduced power consumption, improved coordination between devices, and longer battery life, among other benefits.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of link establishment procedures for UWB sidelinks as described herein, or the at least one processor 1335 and the at least one memory 1325 may be otherwise configured to, individually or collectively, perform or support such operations.

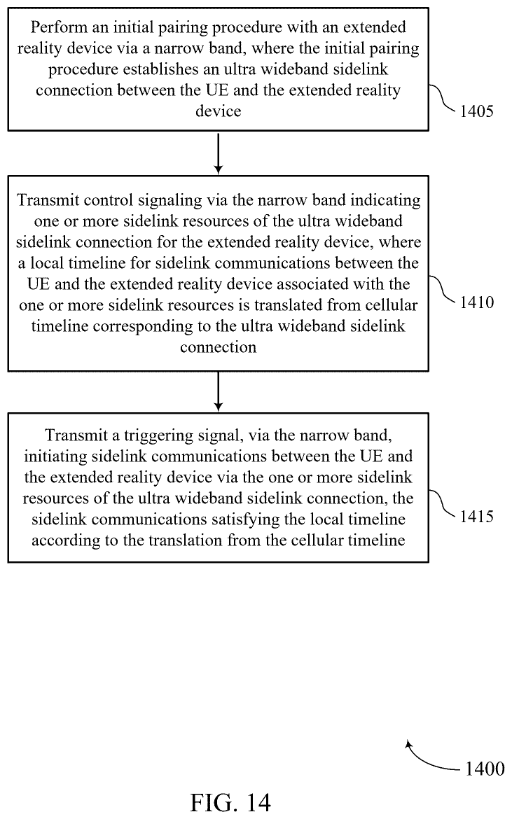

FIG. 14 shows a flowchart illustrating a method 1400 that supports link establishment procedures for UWB sidelinks in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include performing an initial pairing procedure with an extended reality device via a narrow band, where the initial pairing procedure establishes an UWB sidelink connection between the UE and the extended reality device. The operations of 1405 may be performed in accordance with examples as disclosed herein. In some examples, aspects of the operations of 1405 may be performed by a pairing component 825 as described with reference to FIG. 8.

At 1410, the method may include transmitting control signaling via the narrow band indicating one or more sidelink resources of the UWB sidelink connection for the extended reality device, where a local timeline for sidelink communications between the UE and the extended reality device associated with the one or more sidelink resources is translated from cellular timeline corresponding to the UWB sidelink connection. The operations of 1410 may be performed in accordance with examples as disclosed herein. In some examples, aspects of the operations of 1410 may be performed by a resource component 830 as described with reference to FIG. 8.

At 1415, the method may include transmitting a triggering signal, via the narrow band, initiating sidelink communications between the UE and the extended reality device via the one or more sidelink resources of the UWB sidelink connection, the sidelink communications satisfying the local timeline according to the translation from the cellular timeline. The operations of 1415 may be performed in accordance with examples as disclosed herein. In some examples, aspects of the operations of 1415 may be performed by a triggering component 835 as described with reference to FIG. 8.

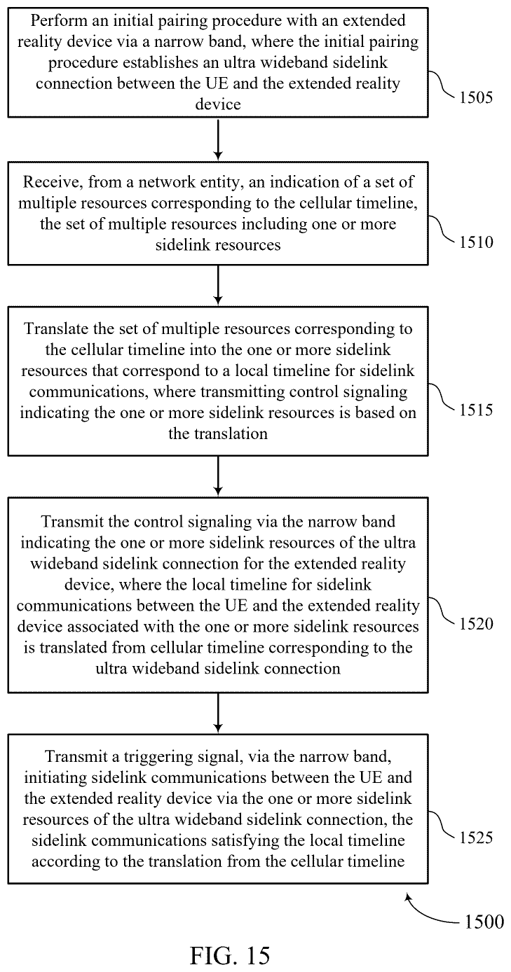

FIG. 15 shows a flowchart illustrating a method 1500 that supports link establishment procedures for UWB sidelinks in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include performing an initial pairing procedure with an extended reality device via a narrow band, where the initial pairing procedure establishes an UWB sidelink connection between the UE and the extended reality device. The operations of 1505 may be performed in accordance with examples as disclosed herein. In some examples, aspects of the operations of 1505 may be performed by a pairing component 825 as described with reference to FIG. 8.

At 1510, the method may include receiving, from a network entity, an indication of a set of multiple resources corresponding to the cellular timeline, the set of multiple resources including the one or more sidelink resources. The operations of 1510 may be performed in accordance with examples as disclosed herein. In some examples, aspects of the operations of 1510 may be performed by a resource component 830 as described with reference to FIG. 8.

At 1515, the method may include translating the set of multiple resources corresponding to the cellular timeline into the one or more sidelink resources that correspond to the local timeline for sidelink communications, where transmitting the control signaling indicating the one or more sidelink resources is based on the translation. The operations of 1515 may be performed in accordance with examples as disclosed herein. In some examples, aspects of the operations of 1515 may be performed by a resource component 830 as described with reference to FIG. 8.

At 1520, the method may include transmitting control signaling via the narrow band indicating one or more sidelink resources of the UWB sidelink connection for the extended reality device, where a local timeline for sidelink communications between the UE and the extended reality device associated with the one or more sidelink resources is translated from cellular timeline corresponding to the UWB sidelink connection. The operations of 1520 may be performed in accordance with examples as disclosed herein. In some examples, aspects of the operations of 1520 may be performed by a resource component 830 as described with reference to FIG. 8.

At 1525, the method may include transmitting a triggering signal, via the narrow band, initiating sidelink communications between the UE and the extended reality device via the one or more sidelink resources of the UWB sidelink connection, the sidelink communications satisfying the local timeline according to the translation from the cellular timeline. The operations of 1525 may be performed in accordance with examples as disclosed herein. In some examples, aspects of the operations of 1525 may be performed by a triggering component 835 as described with reference to FIG. 8.

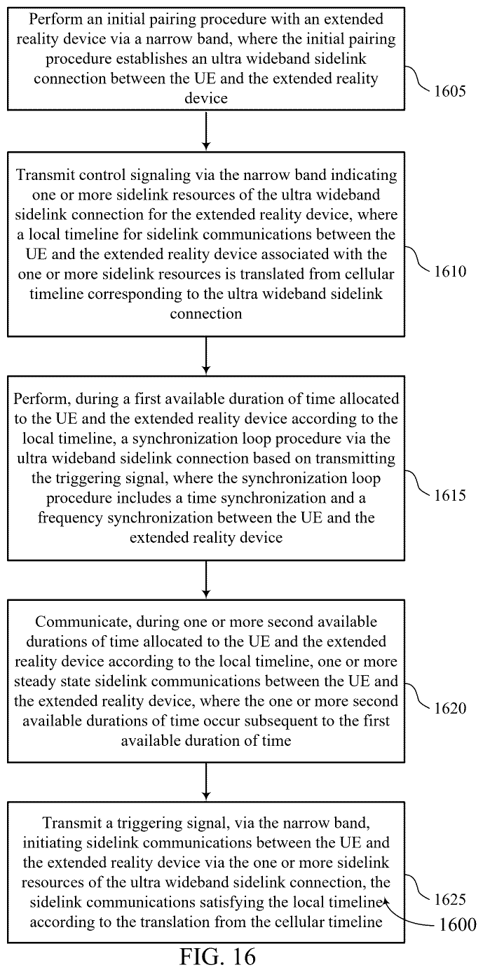

FIG. 16 shows a flowchart illustrating a method 1600 that supports link establishment procedures for UWB sidelinks in accordance with one or more aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1605, the method may include performing an initial pairing procedure with an extended reality device via a narrow band, where the initial pairing procedure establishes an UWB sidelink connection between the UE and the extended reality device. The operations of 1605 may be performed in accordance with examples as disclosed herein. In some examples, aspects of the operations of 1605 may be performed by a pairing component 825 as described with reference to FIG. 8.

At 1610, the method may include performing, during a first available duration of time allocated to the UE and the extended reality device according to the local timeline, a synchronization loop procedure via the UWB sidelink connection based on transmitting the triggering signal, where the synchronization loop procedure includes a time synchronization and a frequency synchronization between the UE and the extended reality device. The operations of 1610 may be performed in accordance with examples as disclosed herein. In some examples, aspects of the operations of 1610 may be performed by a synchronization component 840 as described with reference to FIG. 8.

At 1615, the method may include transmitting control signaling via the narrow band indicating one or more sidelink resources of the UWB sidelink connection for the extended reality device, where a local timeline for sidelink communications between the UE and the extended reality device associated with the one or more sidelink resources is translated from cellular timeline corresponding to the UWB sidelink connection. The operations of 1615 may be performed in accordance with examples as disclosed herein. In some examples, aspects of the operations of 1615 may be performed by a resource component 830 as described with reference to FIG. 8.

At 1620, the method may include transmitting a triggering signal, via the narrow band, initiating sidelink communications between the UE and the extended reality device via the one or more sidelink resources of the UWB sidelink connection, the sidelink communications satisfying the local timeline according to the translation from the cellular timeline. The operations of 1620 may be performed in accordance with examples as disclosed herein. In some examples, aspects of the operations of 1620 may be performed by a triggering component 835 as described with reference to FIG. 8.

At 1625, the method may include communicating, during one or more second available durations of time allocated to the UE and the extended reality device according to the local timeline, one or more steady state sidelink communications between the UE and the extended reality device, where the one or more second available durations of time occur subsequent to the first available duration of time. The operations of 1625 may be performed in accordance with examples as disclosed herein. In some examples, aspects of the operations of 1625 may be performed by a sidelink component 845 as described with reference to FIG. 8.

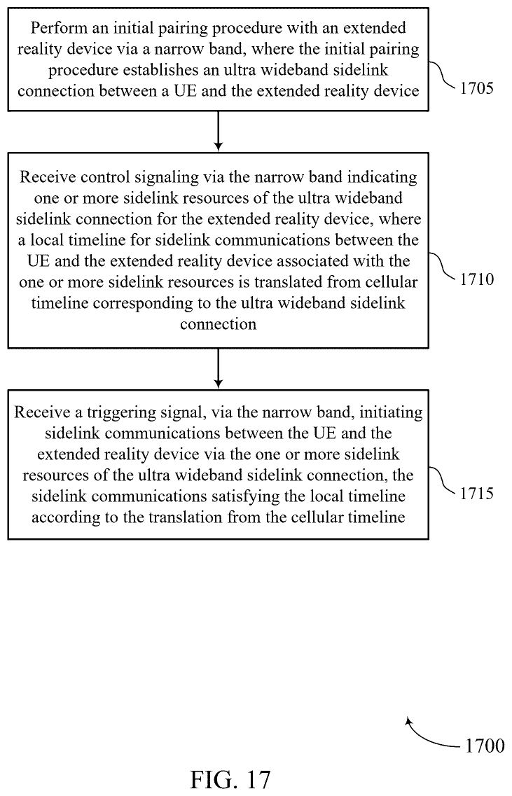

FIG. 17 shows a flowchart illustrating a method 1700 that supports link establishment procedures for UWB sidelinks in accordance with one or more aspects of the present disclosure. The operations of the method 1700 may be implemented by an XR device or its components as described herein. For example, the operations of the method 1700 may be performed by an XR device as described with reference to FIGS. 1 through 5 and 10 through 13. In some examples, an XR device may execute a set of instructions to control the functional elements of the XR device to perform the described functions. Additionally, or alternatively, the XR device may perform aspects of the described functions using special-purpose hardware.

At 1705, the method may include performing an initial pairing procedure with an extended reality device via a narrow band, where the initial pairing procedure establishes an UWB sidelink connection between a UE and the extended reality device. The operations of 1705 may be performed in accordance with examples as disclosed herein. In some examples, aspects of the operations of 1705 may be performed by a pairing component 1225 as described with reference to FIG. 12.

At 1710, the method may include receiving control signaling via the narrow band indicating one or more sidelink resources of the UWB sidelink connection for the extended reality device, where a local timeline for sidelink communications between the UE and the extended reality device associated with the one or more sidelink resources is translated from cellular timeline corresponding to the UWB sidelink connection. The operations of 1710 may be performed in accordance with examples as disclosed herein. In some examples, aspects of the operations of 1710 may be performed by a resource component 1230 as described with reference to FIG. 12.

At 1715, the method may include receiving a triggering signal, via the narrow band, initiating sidelink communications between the UE and the extended reality device via the one or more sidelink resources of the UWB sidelink connection, the sidelink communications satisfying the local timeline according to the translation from the cellular timeline. The operations of 1715 may be performed in accordance with examples as disclosed herein. In some examples, aspects of the operations of 1715 may be performed by a triggering component 1235 as described with reference to FIG. 12.

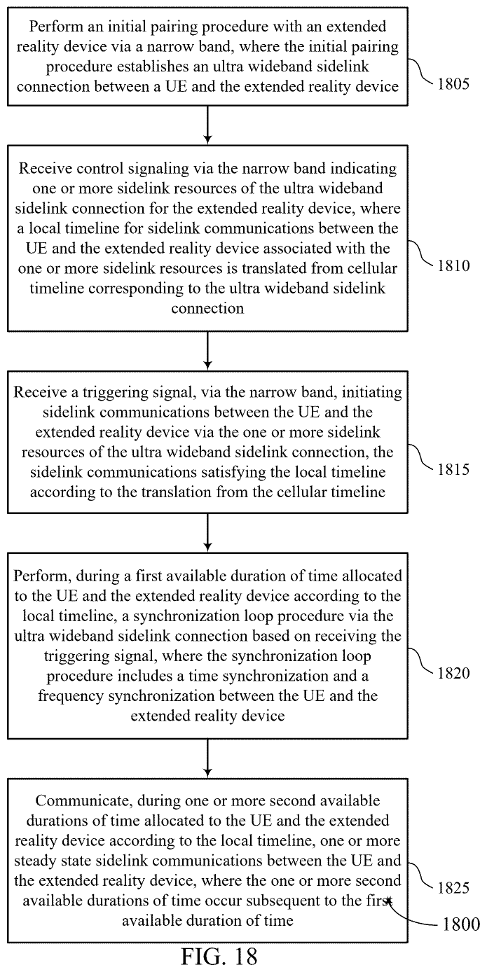

FIG. 18 shows a flowchart illustrating a method 1800 that supports link establishment procedures for UWB sidelinks in accordance with one or more aspects of the present disclosure. The operations of the method 1800 may be implemented by an XR device or its components as described herein. For example, the operations of the method 1800 may be performed by an XR device as described with reference to FIGS. 1 through 5 and 10 through 13. In some examples, an XR device may execute a set of instructions to control the functional elements of the XR device to perform the described functions. Additionally, or alternatively, the XR device may perform aspects of the described functions using special-purpose hardware.

At 1805, the method may include performing an initial pairing procedure with an extended reality device via a narrow band, where the initial pairing procedure establishes an UWB sidelink connection between a UE and the extended reality device. The operations of 1805 may be performed in accordance with examples as disclosed herein. In some examples, aspects of the operations of 1805 may be performed by a pairing component 1225 as described with reference to FIG. 12.

At 1810, the method may include receiving control signaling via the narrow band indicating one or more sidelink resources of the UWB sidelink connection for the extended reality device, where a local timeline for sidelink communications between the UE and the extended reality device associated with the one or more sidelink resources is translated from cellular timeline corresponding to the UWB sidelink connection. The operations of 1810 may be performed in accordance with examples as disclosed herein. In some examples, aspects of the operations of 1810 may be performed by a resource component 1230 as described with reference to FIG. 12.

At 1815, the method may include receiving a triggering signal, via the narrow band, initiating sidelink communications between the UE and the extended reality device via the one or more sidelink resources of the UWB sidelink connection, the sidelink communications satisfying the local timeline according to the translation from the cellular timeline. The operations of 1815 may be performed in accordance with examples as disclosed herein. In some examples, aspects of the operations of 1815 may be performed by a triggering component 1235 as described with reference to FIG. 12.

At 1820, the method may include performing, during a first available duration of time allocated to the UE and the extended reality device according to the local timeline, a synchronization loop procedure via the UWB sidelink connection based on receiving the triggering signal, where the synchronization loop procedure includes a time synchronization and a frequency synchronization between the UE and the extended reality device. The operations of 1820 may be performed in accordance with examples as disclosed herein. In some examples, aspects of the operations of 1820 may be performed by a synchronization component 1240 as described with reference to FIG. 12.

At 1825, the method may include communicating, during one or more second available durations of time allocated to the UE and the extended reality device according to the local timeline, one or more steady state sidelink communications between the UE and the extended reality device, where the one or more second available durations of time occur subsequent to the first available duration of time. The operations of 1825 may be performed in accordance with examples as disclosed herein. In some examples, aspects of the operations of 1825 may be performed by a sidelink component 1245 as described with reference to FIG. 12.

The following provides an overview of aspects of the present disclosure:

### Aspect 1

A method for wireless communications at a UE, comprising: performing an initial pairing procedure with an XR device via a NB, wherein the initial pairing procedure establishes an UWB sidelink connection between the UE and the XR device; transmitting control signaling via the NB indicating one or more sidelink resources of the UWB sidelink connection for the XR device, wherein a local timeline for sidelink communications between the UE and the XR device associated with the one or more sidelink resources is translated from cellular timeline corresponding to the UWB sidelink connection; and transmitting a triggering signal, via the NB, initiating sidelink communications between the UE and the XR device via the one or more sidelink resources of the UWB sidelink connection, the sidelink communications satisfying the local timeline according to the translation from the cellular timeline.

### Aspect 2

The method of aspect 1, further comprising: receiving, from a network entity, an indication of a plurality of resources corresponding to the cellular timeline, the plurality of resources comprising the one or more sidelink resources; and translating the plurality of resources corresponding to the cellular timeline into the one or more sidelink resources that correspond to the local timeline for sidelink communications, wherein transmitting the control signaling indicating the one or more sidelink resources is based at least in part on the translation.

### Aspect 3

The method of aspect 2, wherein the plurality of resources are allocated for sidelink communications between the UE and the XR device according to a periodic communication pattern, and the periodic communication pattern comprises a time-domain resource grid according to the cellular timeline.

### Aspect 4

The method of aspect 3, wherein a first set of time durations of the periodic communication pattern correspond to the UE and the XR device, and a second set of time durations of the periodic communication pattern correspond to a second UE and a second XR device.

### Aspect 5

The method of any of aspects 1 through 4, further comprising: performing, during a first available duration of time allocated to the UE and the XR device according to the local timeline, a synchronization loop procedure via the UWB sidelink connection based at least in part on transmitting the triggering signal, wherein the synchronization loop procedure comprises a time synchronization and a frequency synchronization between the UE and the XR device; and communicating, during one or more second available durations of time allocated to the UE and the XR device according to the local timeline, one or more steady state sidelink communications between the UE and the XR device, wherein the one or more second available durations of time occur subsequent to the first available duration of time.

### Aspect 6

The method of aspect 5, wherein the synchronization loop procedure further comprises: receiving one or more first uplink reference signals; transmitting one or more downlink reference signals in accordance with a loop refinement procedure based at least in part on the one or more first uplink reference signals; receiving one or more second uplink reference signals based at least in part on transmitting the one or more downlink reference signals; and performing a downlink equalization response evaluation procedure based at least in part on receiving the one or more second uplink reference signals, one or more synchronization loop corrections via downlink control signaling, or a combination thereof.

### Aspect 7

The method of any of aspects 5 through 8, wherein the time synchronization further comprises: communicating a timeline synchronization message via the NB; and recommunicating the timeline synchronization message via the NB one or more times based at least in part on satisfying a timeline accuracy threshold.

### Aspect 9

The method of aspect 5, further comprising: repeating the synchronization loop procedure one or more times until one or more accuracy thresholds are satisfied.

### Aspect 10

The method of any of aspects 1 through 11, wherein the sidelink communications are activated semi-persistently based on the triggering signal and in accordance with the local timeline.

### Aspect 12

The method of any of aspects 1 through 10, wherein performing the initial pairing procedure is based at least in part on a successful LBT procedure.

### Aspect 13

The method of any of aspects 1 through 14, further comprising: sending one or more first transmissions via the one or more sidelink resources of the UWB sidelink connection according to the local timeline; monitoring for one or more second transmissions via the one or more sidelink resources of the UWB sidelink connection according to the local timeline; and retransmitting the triggering signal based at least in part on the monitoring.

### Aspect 15

The method of any of aspects 1 through 13, further comprising: generating a pre-equalization matrix the sidelink communications based at least in part on a channel reciprocity state.

### Aspect 16

The method of aspect 15, wherein generating the pre-equalization matrix further comprises: receiving one or more uplink channel estimation reference signals via an uplink channel, the uplink channel corresponding to the UWB sidelink connection; performing an estimation of one or more characteristics of a downlink channel based at least in part on receiving the one or more uplink channel estimation reference signals; and performing the sidelink communications according to one or more equalization matrices based at least in part on performing an evaluation of the one or more equalization matrices and based at least in part on a channel reciprocity according to the channel reciprocity state.

### Aspect 17

The method of aspect 15, wherein generating the pre-equalization matrix further comprises: transmitting one or more non-equalized downlink reference signals via a downlink channel, the downlink channel corresponding to the UWB sidelink connection; receiving, in a next available uplink slot according to the local timeline, an indication of one or more samples of the one or more non-equalized downlink reference signals; performing an estimation of one or more characteristics of the downlink channel based at least in part on receiving the indication; and performing the sidelink communications according to one or more equalization matrices based at least in part on performing an evaluation of the one or more equalization matrices and based at least in part on a lack of channel reciprocity according to the channel reciprocity state.

### Aspect 18

The method of any of aspects 1 through 17, further comprising: receiving, from a network entity, one or more reference clock signals, wherein the one or more reference clock signals are based on the cellular timeline, and wherein the XR device is synchronized with the cellular timeline based at least in part on the one or more reference clock signals.

### Aspect 19

A method for wireless communications at an XR device, comprising: performing an initial pairing procedure with an XR device via a NB, wherein the initial pairing procedure establishes an UWB sidelink connection between a UE and the XR device; receiving control signaling via the NB indicating one or more sidelink resources of the UWB sidelink connection for the XR device, wherein a local timeline for sidelink communications between the UE and the XR device associated with the one or more sidelink resources is translated from cellular timeline corresponding to the UWB sidelink connection; and receiving a triggering signal, via the NB, initiating sidelink communications between the UE and the XR device via the one or more sidelink resources of the UWB sidelink connection, the sidelink communications satisfying the local timeline according to the translation from the cellular timeline.

### Aspect 20

The method of aspect 19, further comprising: performing, during a first available duration of time allocated to the UE and the XR device according to the local timeline, a synchronization loop procedure via the UWB sidelink connection based at least in part on receiving the triggering signal, wherein the synchronization loop procedure comprises a time synchronization and a frequency synchronization between the UE and the XR device; and communicating, during one or more second available durations of time allocated to the UE and the XR device according to the local timeline, one or more steady state sidelink communications between the UE and the XR device, wherein the one or more second available durations of time occur subsequent to the first available duration of time.

### Aspect 21

The method of aspect 20, wherein the synchronization loop procedure further comprises: transmitting one or more first uplink reference signals; receiving one or more downlink reference signals in accordance with a loop refinement procedure based at least in part on the one or more first uplink reference signals; and transmitting one or more second uplink reference signals based at least in part on transmitting the one or more downlink reference signals.

### Aspect 22

The method of any of aspects 20 through 21, wherein the time synchronization further comprises: communicating a timeline synchronization message via the NB; and recommunicating the timeline synchronization message via the NB one or more times based at least in part on satisfying a timeline accuracy threshold.

### Aspect 23

The method of any of aspects 20 through 22, further comprising: repeating the synchronization loop procedure one or more times until one or more accuracy thresholds are satisfied.

### Aspect 24

The method of any of aspects 19 through 23, wherein the sidelink communications are activated semi-persistently based on the triggering signal and in accordance with the local timeline.

### Aspect 25

The method of any of aspects 19 through 24, wherein performing the initial pairing procedure is based at least in part on a successful LBT procedure.

### Aspect 26

The method of any of aspects 19 through 25, further comprising: generating a pre-equalization matrix for the sidelink communications based at least in part on a channel reciprocity state.

### Aspect 27

The method of aspect 26, wherein generating the pre-equalization matrix further comprises: transmitting one or more uplink channel estimation reference signals via an uplink channel, the uplink channel corresponding to the UWB sidelink connection; and performing the sidelink communications according to the pre-equalization matrix based at least in part on transmitting the one or more uplink channel estimation reference signals and based at least in part on a channel reciprocity according to the channel reciprocity state.

### Aspect 28

The method of aspect 26, wherein generating the pre-equalization matrix further comprises: receiving one or more non-equalized downlink reference signals via a downlink channel based at least in part on an absence of a channel reciprocity according to the channel reciprocity state, the downlink channel corresponding to the UWB sidelink connection; sampling the one or more non-equalized downlink reference signals; transmitting, in a next available uplink slot according to the local timeline, an indication of one or more samples of the one or more non-equalized downlink reference signals; and performing the sidelink communications according to the pre-equalization matrix based at least in part on sampling the one or more non-equalized downlink reference signals and based at least in part on a lack of channel reciprocity according to the channel reciprocity state.

### Aspect 29

The method of any of aspects 19 through 28, further comprising: receiving one or more reference clock signals, wherein the one or more reference clock signals are based on the cellular timeline, and wherein the XR device is synchronized with the cellular timeline based at least in part on the one or more reference clock signals.

### Aspect 30

A UE for wireless communications, comprising one or more memories storing processor-executable code, and one or more processors coupled with the one or more memories and individually or collectively operable to execute the code to cause the UE to perform a method of any of aspects 1 through 18.

### Aspect 31

A UE for wireless communications, comprising at least one means for performing a method of any of aspects 1 through 18.

### Aspect 32

A non-transitory computer-readable medium storing code for wireless communications, the code comprising instructions executable by one or more processors to perform a method of any of aspects 1 through 18.

### Aspect 33

An XR device for wireless communications, comprising one or more memories storing processor-executable code, and one or more processors coupled with the one or more memories and individually or collectively operable to execute the code to cause the XR device to perform a method of any of aspects 19 through 29.

### Aspect 34

An XR device for wireless communications, comprising at least one means for performing a method of any of aspects 19 through 29.

### Aspect 35

A non-transitory computer-readable medium storing code for wireless communications, the code comprising instructions executable by one or more processors to perform a method of any of aspects 19 through 29.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a user equipment (UE), comprising:
performing an initial pairing procedure with an extended reality device via a narrow band, wherein the initial pairing procedure establishes an ultra wideband sidelink connection between the UE and the extended reality device;
transmitting control signaling via the narrow band indicating one or more sidelink resources of the ultra wideband sidelink connection for the extended reality device, wherein a local timeline for sidelink communications between the UE and the extended reality device associated with the one or more sidelink resources is translated from cellular timeline corresponding to the ultra wideband sidelink connection; and
transmitting a triggering signal, via the narrow band, initiating sidelink communications between the UE and the extended reality device via the one or more sidelink resources of the ultra wideband sidelink connection, the sidelink communications satisfying the local timeline according to the translation from the cellular timeline.

2. The method of claim 1, further comprising:
receiving, from a network entity, an indication of a plurality of resources corresponding to the cellular timeline, the plurality of resources comprising the one or more sidelink resources; and
translating the plurality of resources corresponding to the cellular timeline into the one or more sidelink resources that correspond to the local timeline for sidelink communications, wherein transmitting the control signaling indicating the one or more sidelink resources is based at least in part on the translation.

3. The method of claim 2, wherein the plurality of resources are allocated for sidelink communications between the UE and the extended reality device according to a periodic communication pattern, and the periodic communication pattern comprises a time-domain resource grid according to the cellular timeline.

4. The method of claim 3, wherein a first set of time durations of the periodic communication pattern correspond to the UE and the extended reality device, and a second set of time durations of the periodic communication pattern correspond to a second UE and a second extended reality device.

5. The method of claim 1, further comprising:
performing, during a first available duration of time allocated to the UE and the extended reality device according to the local timeline, a synchronization loop procedure via the ultra wideband sidelink connection based at least in part on transmitting the triggering signal, wherein the synchronization loop procedure comprises a time synchronization and a frequency synchronization between the UE and the extended reality device; and
communicating, during one or more second available durations of time allocated to the UE and the extended reality device according to the local timeline, one or more steady state sidelink communications between the UE and the extended reality device, wherein the one or more second available durations of time occur subsequent to the first available duration of time.

6. The method of claim 5, wherein the synchronization loop procedure further comprises:
receiving one or more first uplink reference signals;
transmitting one or more downlink reference signals in accordance with a loop refinement procedure based at least in part on the one or more first uplink reference signals;
receiving one or more second uplink reference signals based at least in part on transmitting the one or more downlink reference signals; and
performing a downlink equalization response evaluation procedure based at least in part on receiving the one or more second uplink reference signals, one or more synchronization loop corrections via downlink control signaling, or a combination thereof.

7. The method of claim 5, wherein the time synchronization further comprises:
communicating a timeline synchronization message via the narrow band; and
recommunicating the timeline synchronization message via the narrow band one or more times based at least in part on satisfying a timeline accuracy threshold.

8. The method of claim 5, further comprising:
repeating the synchronization loop procedure one or more times until one or more accuracy thresholds are satisfied.

9. The method of claim 1, wherein the sidelink communications are activated semi-persistently based on the triggering signal and in accordance with the local timeline.

10. The method of claim 1, wherein performing the initial pairing procedure is based at least in part on a successful listen-before-talk procedure.

11. The method of claim 1, further comprising:
sending one or more first transmissions via the one or more sidelink resources of the ultra wideband sidelink connection according to the local timeline;
monitoring for one or more second transmissions via the one or more sidelink resources of the ultra wideband sidelink connection according to the local timeline; and
retransmitting the triggering signal based at least in part on the monitoring.

12. The method of claim 1, further comprising:
generating a pre-equalization matrix the sidelink communications based at least in part on a channel reciprocity state.

13. The method of claim 12, wherein generating the pre-equalization matrix further comprises:
receiving one or more uplink channel estimation reference signals via an uplink channel, the uplink channel corresponding to the ultra wideband sidelink connection;
performing an estimation of one or more characteristics of a downlink channel based at least in part on receiving the one or more uplink channel estimation reference signals; and
performing the sidelink communications according to one or more equalization matrices based at least in part on performing an evaluation of the one or more equalization matrices and based at least in part on a channel reciprocity according to the channel reciprocity state.

14. The method of claim 12, wherein generating the pre-equalization matrix further comprises:
transmitting one or more non-equalized downlink reference signals via a downlink channel, the downlink channel corresponding to the ultra wideband sidelink connection;
receiving, in a next available uplink slot according to the local timeline, an indication of one or more samples of the one or more non-equalized downlink reference signals;
performing an estimation of one or more characteristics of the downlink channel based at least in part on receiving the indication; and
performing the sidelink communications according to one or more equalization matrices based at least in part on performing an evaluation of the one or more equalization matrices and based at least in part on a lack of channel reciprocity according to the channel reciprocity state.

15. The method of claim 1, further comprising:
receiving, from a network entity, one or more reference clock signals, wherein the one or more reference clock signals are based on the cellular timeline, and wherein the extended reality device is synchronized with the cellular timeline based at least in part on the one or more reference clock signals.

16. A method for wireless communications at an extended reality device, comprising:
performing an initial pairing procedure with an extended reality device via a narrow band, wherein the initial pairing procedure establishes an ultra wideband sidelink connection between a user equipment (UE) and the extended reality device;
receiving control signaling via the narrow band indicating one or more sidelink resources of the ultra wideband sidelink connection for the extended reality device, wherein a local timeline for sidelink communications between the UE and the extended reality device associated with the one or more sidelink resources is translated from cellular timeline corresponding to the ultra wideband sidelink connection; and
receiving a triggering signal, via the narrow band, initiating sidelink communications between the UE and the extended reality device via the one or more sidelink resources of the ultra wideband sidelink connection, the sidelink communications satisfying the local timeline according to the translation from the cellular timeline.

17. The method of claim 16, further comprising:
performing, during a first available duration of time allocated to the UE and the extended reality device according to the local timeline, a synchronization loop procedure via the ultra wideband sidelink connection based at least in part on receiving the triggering signal, wherein the synchronization loop procedure comprises a time synchronization and a frequency synchronization between the UE and the extended reality device; and
communicating, during one or more second available durations of time allocated to the UE and the extended reality device according to the local timeline, one or more steady state sidelink communications between the UE and the extended reality device, wherein the one or more second available durations of time occur subsequent to the first available duration of time.

18. The method of claim 17, wherein the synchronization loop procedure further comprises:
transmitting one or more first uplink reference signals;
receiving one or more downlink reference signals in accordance with a loop refinement procedure based at least in part on the one or more first uplink reference signals; and
transmitting one or more second uplink reference signals based at least in part on transmitting the one or more downlink reference signals.

19. The method of claim 17, wherein the time synchronization further comprises:
communicating a timeline synchronization message via the narrow band; and
recommunicating the timeline synchronization message via the narrow band one or more times based at least in part on satisfying a timeline accuracy threshold.

20. The method of claim 17, further comprising:
repeating the synchronization loop procedure one or more times until one or more accuracy thresholds are satisfied.

21. The method of claim 16, wherein the sidelink communications are activated semi-persistently based on the triggering signal and in accordance with the local timeline.

22. The method of claim 16, wherein performing the initial pairing procedure is based at least in part on a successful listen-before-talk procedure.

23. The method of claim 16, further comprising:
generating a pre-equalization matrix for the sidelink communications based at least in part on a channel reciprocity state.

24. The method of claim 23, wherein generating the pre-equalization matrix further comprises:
transmitting one or more uplink channel estimation reference signals via an uplink channel, the uplink channel corresponding to the ultra wideband sidelink connection; and
performing the sidelink communications according to the pre-equalization matrix based at least in part on transmitting the one or more uplink channel estimation reference signals and based at least in part on a channel reciprocity according to the channel reciprocity state.

25. The method of claim 23, wherein generating the pre-equalization matrix further comprises:
receiving one or more non-equalized downlink reference signals via a downlink channel based at least in part on an absence of a channel reciprocity according to the channel reciprocity state, the downlink channel corresponding to the ultra wideband sidelink connection;
sampling the one or more non-equalized downlink reference signals;
transmitting, in a next available uplink slot according to the local timeline, an indication of one or more samples of the one or more non-equalized downlink reference signals; and
performing the sidelink communications according to the pre-equalization matrix based at least in part on sampling the one or more non-equalized downlink reference signals and based at least in part on a lack of channel reciprocity according to the channel reciprocity state.

26. The method of claim 16, further comprising:
receiving one or more reference clock signals, wherein the one or more reference clock signals are based on the cellular timeline, and wherein the extended reality device is synchronized with the cellular timeline based at least in part on the one or more reference clock signals.

27. A user equipment (UE), comprising:
one or more memories storing processor-executable code; and
one or more processors coupled with the one or more memories and individually or collectively operable to execute the code to cause the UE to:
perform an initial pairing procedure with an extended reality device via a narrow band, wherein the initial pairing procedure establishes an ultra wideband sidelink connection between the UE and the extended reality device;
transmit control signaling via the narrow band indicating one or more sidelink resources of the ultra wideband sidelink connection for the extended reality device, wherein a local timeline for sidelink communications between the UE and the extended reality device associated with the one or more sidelink resources is translated from cellular timeline corresponding to the ultra wideband sidelink connection; and
transmit a triggering signal, via the narrow band, initiating sidelink communications between the UE and the extended reality device via the one or more sidelink resources of the ultra wideband sidelink connection, the sidelink communications satisfying the local timeline according to the translation from the cellular timeline.

28. The UE of claim 27, wherein the one or more processors are individually or collectively further operable to execute the code to cause the UE to:
receive, from a network entity, an indication of a plurality of resources corresponding to the cellular timeline, the plurality of resources comprising the one or more sidelink resources; and
translate the plurality of resources corresponding to the cellular timeline into the one or more sidelink resources that correspond to the local timeline for sidelink communications, wherein transmitting the control signaling indicating the one or more sidelink resources is based at least in part on the translation.

29. The UE of claim 28, wherein:
the plurality of resources are allocated for sidelink communications between the UE and the extended reality device according to a periodic communication pattern, and
the periodic communication pattern comprises a time-domain resource grid according to the cellular timeline.

30. An extended reality device, comprising:
one or more memories storing processor-executable code; and
one or more processors coupled with the one or more memories and individually or collectively operable to execute the code to cause the extended reality device to:
perform an initial pairing procedure with an extended reality device via a narrow band, wherein the initial pairing procedure establishes an ultra wideband sidelink connection between a user equipment (UE) and the extended reality device;
receive control signaling via the narrow band indicating one or more sidelink resources of the ultra wideband sidelink connection for the extended reality device, wherein a local timeline for sidelink communications between the UE and the extended reality device associated with the one or more sidelink resources is translated from cellular timeline corresponding to the ultra wideband sidelink connection; and
receive a triggering signal, via the narrow band, initiating sidelink communications between the UE and the extended reality device via the one or more sidelink resources of the ultra wideband sidelink connection, the sidelink communications satisfying the local timeline according to the translation from the cellular timeline.
